(19) United States
(12) Patent Application Publication
(10) Pub. No.: US 2011/0011368 A1
(43) Pub. Date: Jan. 20, 2011

(54) RECIPROCATING ENGINES

(75) Inventor: Bradley L. Raether, Redmond, OR (US)

Correspondence Address: Schwabe Williamson & Wyatt;PACWEST CENTER, SUITE 1900, 1211 SW FIFTH AVENUE, PORTLAND, OR, 97204, US

(73) Assignee: WAVETECH ENGINES, INC., REDMOND, OR (US)

(21) Appl. No.: 12/758,784

(22) Filed: Apr. 12, 2010

Related U.S. Application Data
(63) Continuation-in-part of application No. 12/040,793, filed on Feb. 29, 2008.
Application No. 12/040,793 is a continuation-in-part of application No. 11/544,817, filed on Oct. 7, 2006, now Pat. No. 7,360,521.
(60) Provisional application No. 60/724,390, filed on Oct. 7, 2005.

(51) Int. Cl. F02B 75/32

(52) U.S. Cl. 123/197.4

(57) ABSTRACT

Engines may include a piston, an undulating circumferential track, and a converter. In some examples, engines may include a body, a liner and a rotating cylinder. The body may have a cylindrical interior defining an axis and may include an inlet opening and an exhaust opening. The liner may be mounted within the cylindrical interior. The rotating cylinder may include a port that is sequentially aligned with the inlet and exhaust openings on the body as the rotating cylinder rotates within the body. The piston may be disposed within the rotating cylinder and configured for reciprocating motion along the axis. The converter may be mounted to the piston, engaged with the undulating circumferential track, and configured to reciprocate with the piston. The track may cause the converter to rotate about the axis as the converter reciprocates along the axis. The rotating cylinder may rotate with the converter.

### RELATED APPLICATION(S)

This application is a continuation-in-part of, and claims priority under 35 U.S.C. §120 to, U.S. patent application Ser. No. 12/040,793, entitled “SYSTEMS AND METHODS FOR FACILITATING CONVERSION BETWEEN RECIPROCATING LINEAR MOTION AND ROTATIONAL MOTION,” filed on Feb. 29, 2008, which is a continuation-in-part of, and claims priority under 35 U.S.C. §120 to, U.S. patent application Ser. No. 11/544,817, entitled “RECIPROCATING ENGINES,” filed on Oct. 7, 2006, now U.S. Pat. No. 7,360,521, which claims priority under 35 U.S.C. §119(e) to U.S. Provisional Application Ser. No. 60/724,390, filed on Oct. 7, 2005. The complete disclosures of the above-identified patent applications are hereby incorporated by reference for all purposes.

### BACKGROUND

It may be desirable to convert reciprocating linear motion to rotational motion, or vice versa, for a variety of reasons. For example, reciprocating engines have long been used to harness the force of combusted fuel, compressed air, steam, or other working fluid within a volume to linearly displace a piston. The desired output, however, is often rotational motion, for example, to turn the wheels of a vehicle, to turn portions of an electrical generator to produce electricity, etc. Conversely, pumps and compressors have long been used to harness the rotational motion of a motor to linearly displace a working fluid. Other mechanical and/or electro-mechanical systems may incorporate systems for facilitating conversion between reciprocating linear motion and rotational motion. A common mechanism for conversion between reciprocating linear motion to rotational motion has long been a connecting rod coupled to a crank arm of a crankshaft.

Examples of reciprocating engines are disclosed in U.S. Pat. Nos. 1,072,860; 1,129,104; 1,572,068; 1,876,506; 2,262,963; 2,401,466; 3,388,603; 3,757,748; 3,916,866; 4,834,033; 4,996,953; 6,386,152; 7,124,716; 7,131,405; in U.S. Patent Application Publication Nos. 2004/0107923; 2004/0149122; 2005/0145210. The disclosures of these and all other publications referenced herein are incorporated by reference in their entirety for all purposes.

### SUMMARY

In some examples, an engine may include a body, a liner, a rotating cylinder, a piston, an undulating circumferential track, and a converter. The body may have a cylindrical interior defining an axis. The body may include an inlet opening and an exhaust opening. The liner may be mounted within the cylindrical interior. The rotating cylinder may be disposed within the liner and may be configured for rotation about the axis and relative to the liner and the body. The rotating cylinder may include a port that is sequentially aligned with the inlet and exhaust openings on the body as the rotating cylinder rotates within the body. The piston may be disposed within the rotating cylinder and configured for reciprocating motion along the axis. The converter may be mounted to the piston, engaged with the undulating circumferential track, and configured to reciprocate with the piston. The track may cause the converter to rotate about the axis as the converter reciprocates along the axis. The rotating cylinder may rotate with the converter.

In some examples, an engine may include a body, first and second undulating circumferential tracks, and a rotating assembly. The body may extend between first and second ends. The body may include an inlet opening, an exhaust opening, and a cylindrical chamber defining an axis. The first and second undulating circumferential tracks may be fixed relative to the body and disposed proximate the respective first and second ends of the body. The rotating assembly may be disposed at least partially within the cylindrical chamber and configured for rotation about the axis and relative to the body. The rotating assembly may include a rotating cylinder, first and second pistons, and first and second converters. The rotating cylinder may have a port axially aligned with the inlet and exhaust openings on the body. The port may be sequentially aligned with the inlet and exhaust openings as the rotating cylinder rotates about the axis. The first and second pistons may be disposed within the rotating cylinder and configured for reciprocating motion along the axis. The first and second pistons may move along the axis in opposite directions. The rotating cylinder and the first and second pistons may collectively define an expandable volume between the first and second pistons. The first converter may be mounted to the first piston and engaged with the first undulating circumferential track. The first track may causes the first converter to rotate about the axis as the first piston reciprocates along the axis. The second converter may be mounted to the second piston and engaged with the second undulating circumferential track. The second track may cause the second converter to rotate about the axis as the second piston reciprocates along the axis. Rotation of the first and second converters about the axis may cause the rotating cylinder to rotate about the axis.

In some examples, an engine may include a piston, an undulating circumferential track and a converter. The piston may be configured for reciprocating motion along an axis. The undulating circumferential track may extend around the axis. The track may include a bearing surface. The converter may be mounted to the piston for reciprocation therewith and may include a contact portion engaged with the bearing surface of the undulating circumferential track. The engagement between the contact portion and the bearing surface of the track may cause the converter to rotate about the axis as the converter reciprocates along the axis. The contact portion may include a sliding surface configured to slide along at least a first portion of the bearing surface and a roller configured to roll along at least a second portion of the bearing surface.

In some examples, an engine may include a piston, an undulating circumferential track and a converter. The piston may be configured for reciprocating motion along an axis. The undulating circumferential track may extend around the axis. The track may include a bearing surface. The converter may be mounted to the piston for reciprocation therewith and may include a contact portion engaged with the bearing surface of the undulating circumferential track. The engagement between the contact portion and the bearing surface of the track may cause the converter to rotate about the axis as the converter reciprocates along the axis. The contact portion may include a sliding surface configured to slide along at least a first portion of the bearing surface and a curved transitional sliding surface configured to slide along at least a second portion of the bearing surface.

### BRIEF DESCRIPTION OF DRAWINGS

FIG. 1 is a schematic illustration of systems and methods for facilitating conversion between reciprocating linear motion and rotational motion.

FIG. 2 is another schematic illustration of systems and methods for facilitating conversion between reciprocating linear motion and rotational motion.

FIG. 3 is another schematic illustration of systems and methods for facilitating conversion between reciprocating linear motion and rotational motion.

FIG. 4 is a schematic illustration of systems for facilitating conversion between reciprocating linear motion and rotational motion, including illustration of the reciprocating linear motion and the rotational motion.

FIG. 5 is a schematic illustration of systems, with the illustrated systems including an element that both linearly reciprocates and rotates.

FIG. 6 is a schematic illustration of systems, with the illustrated systems including a continuous undulating track circumscribing a circular profile and generally defining a cylindrical volume.

FIG. 7 is a graphical representation of non-exclusive examples of profiles of continuous undulating tracks that may be used in systems and methods for facilitating conversion between reciprocating linear motion and rotational motion.

FIG. 8 is a schematic illustration of a reciprocator and a converter of a system as the converter travels along an undulating track.

FIG. 9 is a schematic illustration of a reciprocator and a converter of a system as the converter travels along an undulating track defined by spaced apart opposing surfaces.

FIG. 10 is schematic illustration of a reciprocator and a converter of a system as the converter travels along an undulating track defined by spaced apart opposing surfaces, the converter illustrated in two distinct configurations.

FIG. 11 is an isometric view of a compressed-air engine, the engine including systems for facilitating conversion between reciprocating linear motion and rotational motion.

FIG. 12 is a cross-sectional view of the compressed-air engine of FIG. 11, taken along 12-12.

FIG. 13 is a cross-sectional view of a portion of the compressed-air engine of FIG. 11, taken along 13-13.

FIG. 14 is an isometric exploded view of portions of a non-exclusive example of the system for facilitating conversion between reciprocating linear motion and rotational motion incorporated into the compressed-air engine of FIG. 11.

FIG. 15 is an isometric partially exploded view of the system for facilitating conversion between reciprocating linear motion and rotational motion incorporated into the compressed-air engine of FIG. 11.

FIG. 16 is an isometric view of the system for facilitating conversion between reciprocating linear motion and rotational motion incorporated into the compressed-air engine of FIG. 11.

FIG. 17 is a partial cross-sectional side view of a four cylinder internal combustion engine, the engine including mechanisms for facilitating conversion between reciprocating linear motion and rotational motion.

FIG. 18 is a side view of a piston, connecting rod, retaining nut, and washers of the engine of FIG. 17.

FIG. 19 is a somewhat schematic view of the connecting rod and piston of FIG. 18.

FIG. 20 is a top view of an interchanger unit.

FIG. 21 is a side view of the interchanger unit of FIG. 20.

FIG. 22 is a schematic illustration of rollers of an interchanger unit illustrating movement within a track.

FIG. 23 is a side view of a piston, connecting rod, and interchanger unit.

FIG. 24 is an exploded view of a connecting rod and interchanger unit.

FIG. 25 is a partial cross-sectional view of an interchanger unit.

FIG. 26 is a top view of the thrust-bearing retainer and its associated screws of FIG. 25.

FIG. 27 is a side view of a rotating carrier unit.

FIG. 28 is a top view of the upper carrier bearing support of the rotating carrier unit illustrated in FIG. 27.

FIG. 29 is an exploded view of the rotating carrier of FIG. 27.

FIG. 30 is a top view of the rotating carrier of FIG. 27.

FIG. 31 is a top view a rotating carrier unit and an interchanger unit.

FIG. 32 is a side view of a piston, a connecting rod, an interchanger unit, and rotating carrier unit, shown with the piston corresponding to a top dead center position.

FIG. 33 is another side view of the piston, connecting rod, interchanger unit, and rotating carrier unit of FIG. 32 shown with the piston corresponding to a bottom dead center position.

FIG. 34 is an exploded view of structure defining upper and lower wave races and a spacer.

FIG. 35 is another exploded view of the structure defining the upper and lower wave races and the spacer of FIG. 34.

FIG. 36 is a top view of the structure defining the lower wave race of FIG. 34.

FIG. 37 is bottom view of the structure defining the upper wave race of FIG. 34.

FIG. 38 is an exploded side view of an interchanger block, structure defining wave races and a spacer.

FIG. 39 is a side view of the interchanger block, structure defining wave races and spacer of FIG. 38 shown in an assembled condition.

FIG. 40 is a top view of the spacer FIG. 34.

FIG. 41 is top view an interchanger unit and a lower wave race.

FIG. 42 is a side view of a piston, connecting rod, and interchanger unit shown with the interchanger unit positioned in a wave-shaped track.

FIG. 43 is a side view of the piston, connecting rod, interchanger unit, and wave-shaped track of FIG. 42 shown further with a rotating carrier unit and a stabilizer unit.

FIG. 44 is a schematic cross-sectional view of the connecting rod and stabilizer unit of FIG. 43.

FIG. 45 is a side view of a rotating carrier unit positioned within structure defining a wave-shaped track, and a stabilizer unit.

FIG. 46 is a side view of an interchanger unit and rotating carrier unit including a reciprocator system.

FIG. 47 is a somewhat schematic representation of an engine cylinder and a mechanism for conversion between linear reciprocating motion and rotational motion, shown with the piston in a top dead center position prior to an intake stroke.

FIG. 48 is a somewhat schematic representation of the structure of FIG. 47 shown with the piston during an intake stroke.

FIG. 49 is a somewhat schematic representation of the structure of FIG. 47 shown with the piston in a bottom dead center position.

FIG. 50 is a somewhat schematic representation of the structure of FIG. 47 shown with the piston during a compression stroke.

FIG. 51 is a somewhat schematic representation of the structure of FIG. 47 shown with the piston in a top dead center position prior to combustion, or power, stroke.

FIG. 52 is a somewhat schematic representation of the structure of FIG. 47 shown with the piston during a combustion stroke.

FIG. 53 is a somewhat schematic representation of the structure of FIG. 47 shown with the piston in a bottom dead center position prior to an exhaust stroke.

FIG. 54 is a somewhat schematic representation of the structure of FIG. 47 shown with the piston during an exhaust stroke.

FIG. 55 is a perspective view of a nonexclusive illustrative example of an engine.

FIG. 56 is an exploded view of the engine of FIG. 55.

FIG. 57 is a section view of the engine of FIG. 55, shown with the pistons at a position corresponding to top dead center, taken generally along line 57-57 in FIG. 55.

FIG. 58 is a section view of the engine of FIG. 55, shown with the pistons at a position corresponding to bottom dead center, taken generally along line 57-57 in FIG. 55.

FIG. 59 is a section view of the engine of FIG. 55, shown with the pistons at a position corresponding to top dead center, taken generally along line 59-59 in FIG. 57.

FIG. 60 is a section view of the engine of FIG. 55, shown with the pistons at a position corresponding to top dead center, taken generally along line 60-60 in FIG. 57.

FIG. 61 is a section view of the engine of FIG. 55, shown with the pistons at a position corresponding to bottom dead center, taken generally along line 61-61 in FIG. 58.

FIG. 62 is a section view of the engine of FIG. 55, shown with the pistons at a position corresponding to bottom dead center, and taken generally along line 62-62 in FIG. 58.

FIG. 63 is a section view of another nonexclusive illustrative example of an engine, shown with the piston at a position corresponding to bottom dead center, taken generally along a line corresponding to line 57-57 in FIG. 55.

FIGS. 64-67 are section views of a nonexclusive illustrative example of an internal combustion engine similar to the engine of FIG. 55, taken generally along a line corresponding to line 59-59 in FIG. 57 for the piston(s) at a position corresponding to top dead center and to line 61-61 in FIG. 58 for the piston(s) at a position corresponding to bottom dead center.

FIG. 64 shows the engine at a zero-degree rotational position, with the piston(s) at a position corresponding to top dead center.

FIG. 65 shows the engine at a ninety-degree rotational position, with the piston(s) at a position corresponding to bottom dead center.

FIG. 66 shows the engine at a one-hundred-eighty-degree rotational position, with the piston(s) at a position corresponding to top dead center.

FIG. 67 shows the engine at a two-hundred-seventy-degree rotational position, with the piston at a piston(s) corresponding to bottom dead center.

FIG. 68 is an end view of a nonexclusive illustrative example of a converter shown engaged with a portion of an undulating track.

FIG. 69 is an end view of the converter of FIG. 68 shown engaged with another portion of an undulating track.

FIG. 70 is an end view of another nonexclusive illustrative example of a converter shown engaged with a portion of an undulating track.

FIG. 71 is an end view of the converter of FIG. 70 shown engaged with another portion of an undulating track.

### DETAILED DESCRIPTION

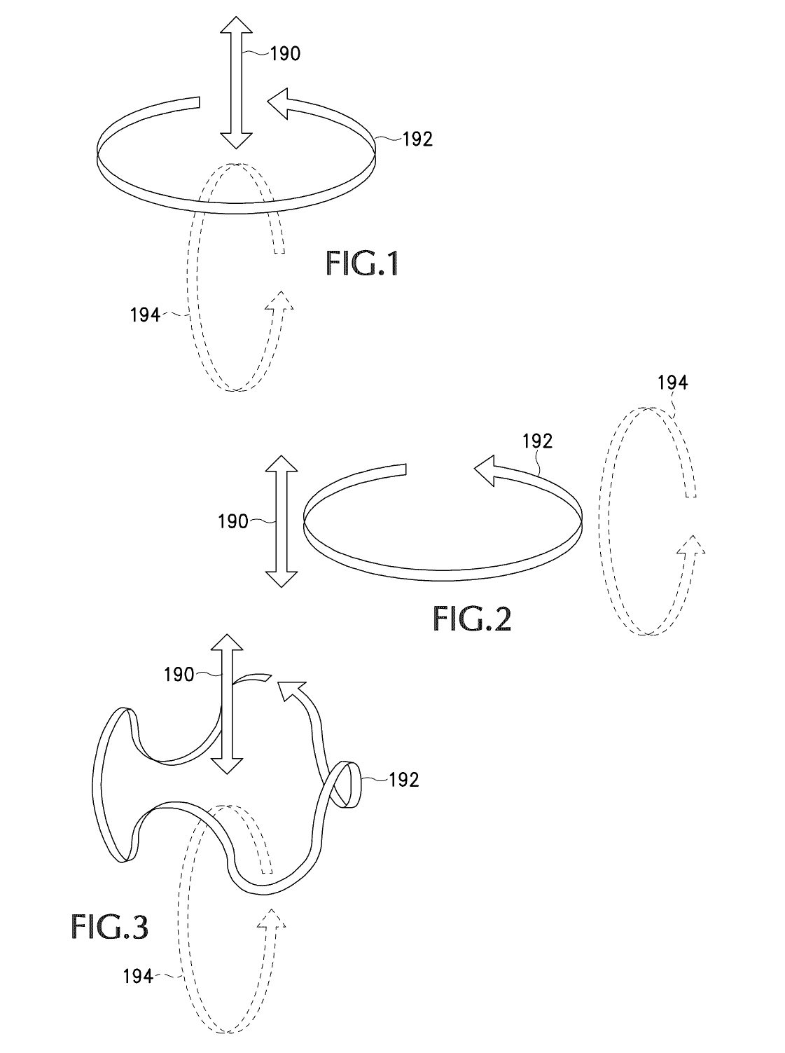

FIGS. 1-3 schematically illustrate systems and methods for facilitating conversion between linear reciprocating motion 190 and rotational motion 192. In some methods and systems, the rotational motion 192 may be within a place that is perpendicular to the reciprocating linear motion 190. In some methods and systems, though not required, the rotation motion 192 may further be converted into a second rotational motion 194. In some such methods and systems, second rotational motion 194 may be within a plane that is perpendicular to the plane of the first rotational motion 192. As illustrated in FIGS. 1 and 2, the translation from linear reciprocating motion to rotational motion may occur in a generally vertical configuration, in a generally horizontal configuration, or in any suitable configuration as may be appropriate for a particular application of a system or method. Additionally, as schematically illustrated in FIG. 3, rotational motion 194 may simultaneously linearly reciprocate, creating a combined rotating and linearly reciprocating motion.

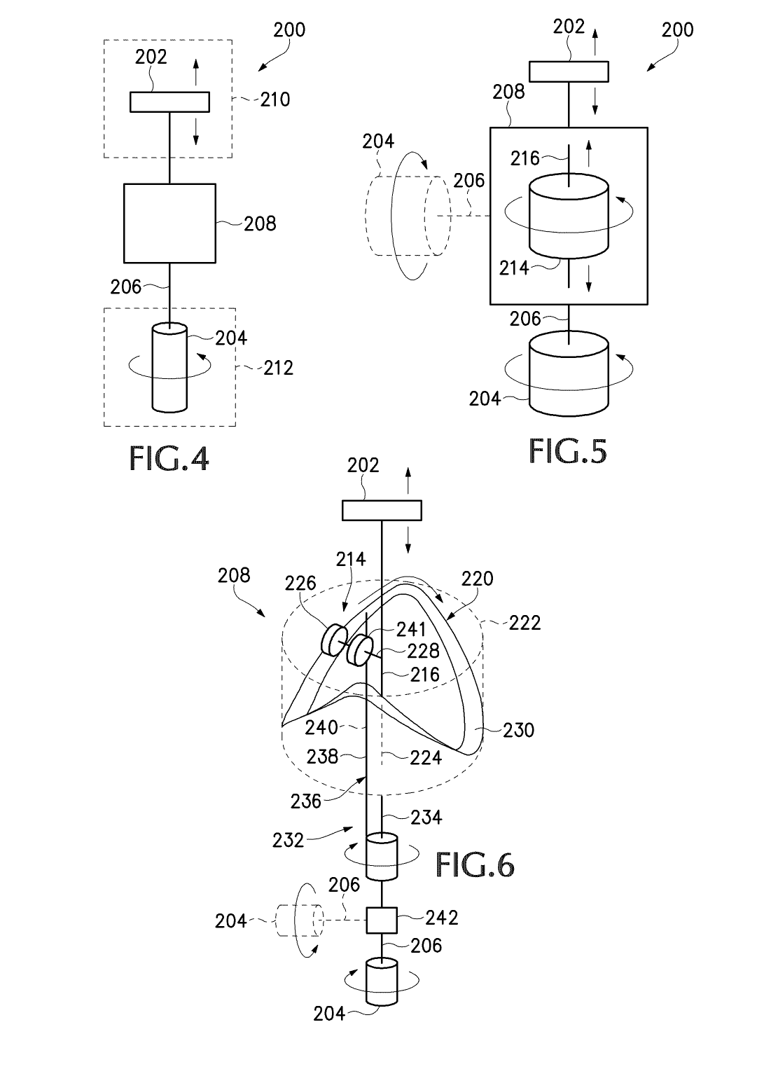

Systems for facilitating conversion between linear reciprocating motion and rotational motion are schematically illustrated in FIG. 4 and indicated generally at 200. Systems 200 include a linear reciprocating element, or reciprocator, 202, a rotating element 204 configured to rotate about an axis 206, and a mechanism 208 for facilitating conversion between the reciprocating linear motion of element 202 and the rotational motion of element 204.

In systems where linear reciprocating motion is converted, or translated, into rotational motion, a system 200 may include a subsystem 210 for harnessing a linear component of a force. For example, the force may be created by the combustion of fuel within a combustion chamber of an internal combustion engine, by compressed air within a cylinder of a compressed-air engine, by a human exerting force on a pedal or other component of a human-powered vehicle, or by any other appropriate input depending on the particular application for which a system 200 may be configured or used.

In the example of an internal combustion engine incorporating a system of the present disclosure, subsystem 210 may include such standard components as a cylinder block, a cylinder head, a fuel delivery system, inlet and exhaust valves, spark plugs, etc. However, an internal combustion engine incorporating a system according to the present disclosure, rather than including an engine cooling system (e.g., in a water-cooled engine or an air-cooled engine), may (but is not required to) have a subsystem 210 that includes insulation of the cylinder block and/or related components. Such insulation may further increase the efficiency of a given engine because the higher the temperature of the combustion gases, the higher the effective pressure on the piston during a power stroke of the engine.

Conversely, in the example of a compressed-air engine incorporating a system of the present disclosure, subsystem 210 may (but is not required to) include means for drawing heat into the cylinder. Such a subsystem may further increase the efficiency of a given engine, again because the higher temperature of the working fluid (i.e., compressed air in a compressed-air engine), the higher the effective pressure within the cylinder and thus the higher the force on the piston during a power stroke of the engine. As compressed air expands into and within a cylinder of a compressed-air engine, it naturally cools. Accordingly, by drawing heat into the cylinder, the compressed air may maintain a higher overall pressure for the duration of a power stroke.

In systems where rotational motion is converted, or translated, into linear reciprocating motion, a system 200 may include a subsystem 212 for harnessing a rotational input motion that is desired to be converted into a reciprocating linear output motion.

As schematically illustrated in FIG. 5, mechanism 208 may include an element 214 that is configured to both linearly reciprocate along and rotate about an axis 216. Element 214 may also be described as a converter. In some systems, axis 216 may be parallel to, or aligned with, the linear motion of reciprocator 202 as generally illustrated in FIG. 2. Stated differently, reciprocator 202 may be configured to linearly reciprocate along the axis about which converter 214 rotates. In such context, “along” may be either parallel or coaxial, and is not limited to only being coaxial. Stated differently, converter 214 may be configured to rotate within a plane that is perpendicular to the linear motion of reciprocator 202.

As schematically illustrated in dashed lines in FIG. 5, axis 206 of rotating element 204 is not required to be parallel or coaxial to the linear motion of reciprocator 202, and similarly is not required to be parallel or coaxial to the axis of rotation of converter 214 (i.e., axis 216). For example, axis 206 may be transverse to axis 216 and/or the linear motion of reciprocator 202. Additionally or alternatively, axis 206 may be perpendicular to axis 216 (e.g., if axis 206 and axis 216 are coplanar). Additionally or alternatively, rotating element 204 may rotate within a plane that is parallel to or aligned with the linear motion of reciprocator 202 and/or axis 216. Other configurations are equally within the scope of the present disclosure, and systems 200 are not limited to the two non-exclusive configurations schematically illustrated in FIG. 5.

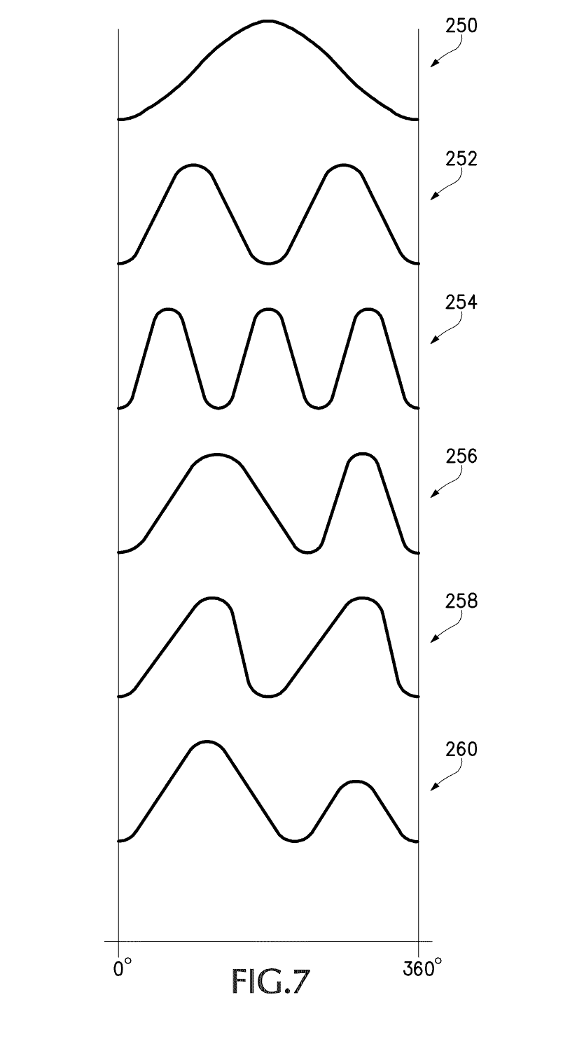

As schematically illustrated in FIG. 6, mechanism 208 may include a continuous undulating track 220 circumscribing a circular profile (e.g., as viewed from above or below in the perspective of FIG. 6) and generally defining a cylindrical volume 222 having a central axis 224. In such embodiments, converter 214 may include a portion 226 that is engaged with the track and a portion 228 that is coupled to reciprocator 202. Accordingly, if and when reciprocator 202 is caused to linearly reciprocate, converter 214 will reciprocate with it. As converter 214 reciprocates, it will be forced to rotate about its axis 216 as portion 226 rides along track 220. Similarly, if and when converter 214 is caused to rotate, it will be forced to linearly reciprocate as portion 226 rides along track 220. As converter 214 reciprocates, reciprocator 202 will reciprocate with it. In some embodiments, though not required, portion 228 may be rotationally coupled to reciprocator 202 such that converter 214 may rotate relative to reciprocator 202.

Portion 226 of converter 214 may take a variety of configurations. For example, converter 214 may include one or more rollers configured to engage and roll along track 220. In such embodiments, track 220 may be defined by a surface 230. As used herein, “rollers” includes gears. Similarly, “surfaces” includes toothed surfaces, for example, configured to mesh with a corresponding gear.

The linear motion of reciprocator 202 may be described as being parallel, coaxial, or aligned with the central axis 224 of cylindrical volume 222. Likewise, the linear motion of converter 214 and the axis of rotation 216 of converter 214 may be parallel, coaxial, or aligned with the central axis of cylindrical volume 222. Stated differently, reciprocator 202 may be described as being configured to linearly reciprocate along the central axis of cylindrical volume 222. In such context, “along” may be either parallel or coaxial, and is not limited to only being coaxial.

Mechanism 208 may further include a second rotating element 232 configured to rotate about an axis 234. Axis 234 may be coaxial with central axis 224. Second rotating element 232 may also be described as a rotator. Rotator 232 may include a portion 236 that is engaged with converter 214 so that rotator 232 rotates with converter 214 and converter 214 linearly reciprocates relative to rotator 232. Portion 236 of rotator 232 may be defined by a track 238 defined by at least a surface 240, and converter 214 may include a portion 241 that is configured to ride along track 238. For example, portion 241 may include one or more rollers configured to engage and roll along track 238. Accordingly, as converter 214 rotates about axis 216, portion 241 will apply force to portion 236 of rotator 232 at a right angle, thereby maintaining a maximum leverage angle between converter 214 and rotator 232 for the full 360° of rotation of converter 214.

As schematically illustrated in FIG. 6 at 242, rotator 232 may be coupled to rotating element 204 so that if and when rotator 232 rotates, rotating element 204 rotates, and vice versa. As previously discussed and schematically illustrated in dashed lines, axis 206 of element 204 is not required to be coaxial with central axis 224.

Undulating track 220 may take a variety of configurations depending on a particular application of a system 200. For example, the shape of track 220 may be predetermined for a particular desired output, whether reciprocating linear motion or rotational motion. Analogizing the shape of track 220 to a waveform, tracks 220 may have various quantities of cycles, various wavelengths, various amplitudes, various slopes, etc. FIG. 7 graphically illustrates non-exclusive examples of track shapes as a track extends around 360° of the cylindrical volume 222. Shape 250, for example, is sinusoidal and includes a single cycle. That is, for every single rotation of converter 214, the converter will reciprocate only once. Shape 252 includes two cycles of equal wavelengths and rather than being sinusoidal, includes linear portions (i.e., with constant slopes). Shape 254 includes three cycles of equal wavelengths. Shape 256, on the other hand, includes two cycles with different wavelengths. Shape 258 includes two cycles with a saw-tooth type profile. That is, each cycle of shape 258 has a down-slope that is steeper than its up-slope (or vice versa, depending on the direction of rotation). Shape 260 includes two cycles with different wavelengths and different amplitudes. The track shapes illustrated in FIG. 7 are provided as non-exclusive examples only, and the present disclosure is not limited to the illustrated shapes. Track shapes may incorporate portions of the shapes illustrated as well as any other appropriate shape for a particular application in which a system 200 is used.

Various shapes of tracks may be implemented for a variety of purposes. For example, the efficiency, power, torque, and other properties of a four-cycle internal combustion engine may be affected by the manipulation of the duration of the various strokes (i.e., intake, compression, power, and exhaust) relative to each other.

Additionally or alternatively, by varying the slope of various portions of the track, the conversion from reciprocating linear motion of an input force (e.g., harnessed from the combustion in an internal combustion engine or from air pressure in a compressed-air engine) to the rotational motion of an output torque (or vice versa), may be optimized. The slope of a given portion of track may be described in terms of an angle relative to the central axis 224, if the respective portion were perpendicularly projected on plane containing the central axis. For example, an optimum slope for the conversion from reciprocating linear motion to rotational motion (or vice versa) may be 45 degrees; however, other optimum slopes are equally within the scope of the present disclosure.

Additionally or alternatively, the radii of curvature of the peaks and troughs of a track shape may be varied to optimize a desired output. For example, the smaller the radii of curvature, the greater the lengths of track portions between peaks and troughs. However, optimum radii may exist for a particular system's configuration. For example, the transition of the converter from an up-slope to a down-slope (and/or vice versa) of the track may affect the wear on various parts of the system. For example, the shorter the radii of curvature, the harsher the transition of a converter from an up-slope to a down-slope (and vice versa) may be, simply due to the deceleration and subsequent acceleration in the vertical direction (when viewed from the perspective of the accompanying figures) of the converter.

The shape of the track may be described in terms of portions having slopes, or angles, that maximize the output torque or force corresponding to either rotational motion or linearly reciprocating motion output by a system, and when compared to the radii of curvature of the peaks and troughs of the track, may be described as accounting for a percentage of overall track length. For example, a track may include portions that are angled relative to the central axis to maximize the output torque or force and that account for at least 50 percent of the track. Additionally or alternatively, a track may include portions that are angled relative to the central axis to maximize the output torque or force and that account for at least 70 percent of the track. Additionally or alternatively, a track may include portions that are angled relative to the central axis to maximize the output torque or force and that account for at least 90 percent of the track. Additionally or alternatively, a track may include portions that are angled relative to the central axis to maximize the output torque or force and that account for at least 95 percent of the track. Additionally or alternatively, a track may include portions that are angled relative to the central axis to maximize the output torque or force and that account for at least 97 percent of the track. Additionally or alternatively, a track may include portions that are angled relative to the central axis to maximize the output torque or force and that account for at least 99 percent of the track. Other configurations are equally within the scope of the present disclosure.

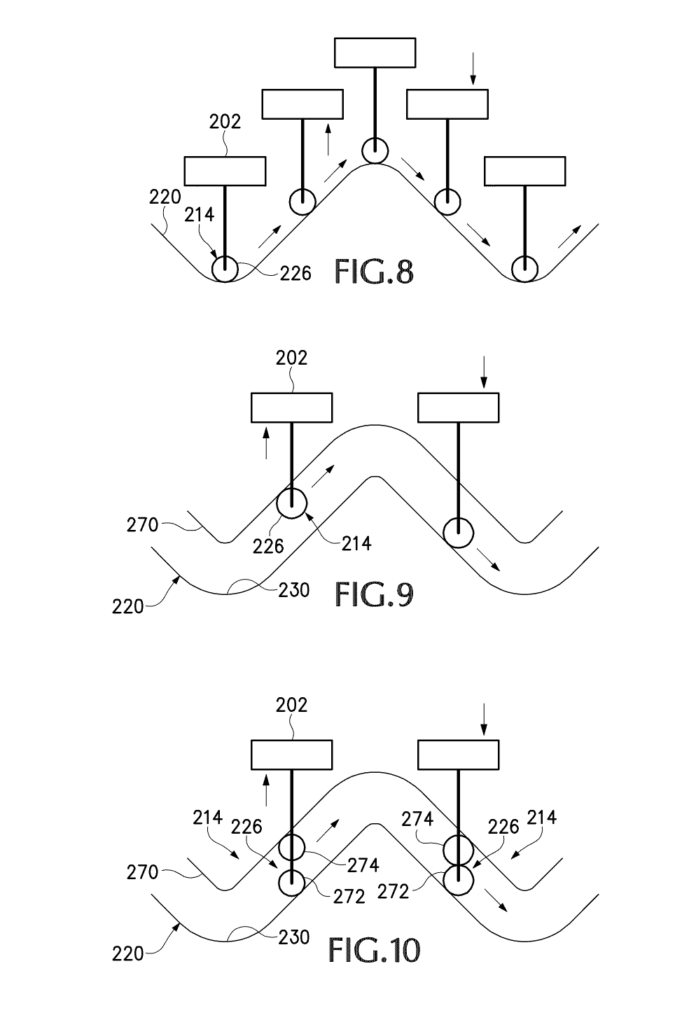

FIGS. 8-10 schematically illustrate the reciprocation of reciprocator 202 and the corresponding reciprocation and rotation of converter 214 relative to track 220. As indicated by the vertical arrows, an upward force on the reciprocator will cause the converter to travel up the track's slope, and a downward force on the reciprocator will cause the converter to travel down the track's slope. Similarly, an input of rotational motion will cause the converter to travel along the track.

FIG. 9 schematically illustrates a track 220 that is defined by a pair of spaced apart surfaces. Stated differently, track 220 may be defined by a first surface 230 and a second surface 270 opposing and spaced from the first surface. In this illustration, portion 226 of converter 214 includes a single roller. As the converter reciprocates in a first direction and the roller rides along the track on an up-slope, the roller engages second surface 270, and as the converter reciprocates in a second and opposite direction and the roller rides along the track on a down-slope, the roller engages first surface 230. In such a configuration (i.e., a single roller between spaced apart surfaces), the surfaces of the track must be spaced greater than the diameter of the roller. Otherwise, the roller will be prevented from actually rolling and instead will drag through the track. However, the space between the two surfaces should not be too great, or the transition from an up-slope to a down-slope (and/or vice versa) may be harsh, as the roller transitions from the second surface to the first surface (and/or vice versa).

FIG. 10 schematically illustrates two distinct configurations of a portion 226 of a converter 214. In both configurations illustrated, portion 226 includes a first roller 272 engaged with first surface 230 of track 220 and a second roller 274 engaged with second surface 270 of track 220. In the example illustrated at left and riding along the up-slope of the track, the first and second rollers are spaced from each other and may independently roll along the corresponding surfaces of the track. In the example illustrated at right and riding along the down-slope of the track, the first and second rollers are not spaced apart from each other and are instead engaged with each other. Accordingly, as first roller 272 rotates clockwise to roll along first surface 230 and second roller 272 rotates counter clockwise to roll along second surface 270, the surfaces of the rollers are in rolling contact with each other.

Systems 200 may be used in a variety of applications. As mentioned, reciprocating engines often convert the reciprocating linear motion of a piston or pistons into the rotational motion of a crankshaft using a connecting rod and crank configuration. An engine's power, torque, and efficiency are all affected by how well the engine converts the reciprocating linear motion to rotational motion. The replacement of the typical connecting rod and crank configuration with systems 200 in a given engine will provide dramatic improvements to the engine's power, torque, and efficiency. This is because, except when portion 226 of converter 214 is engaged with a peak or trough of the undulating track, maximum leverage between the reciprocating linear motion of reciprocator 202 and the track for the transition to rotational motion of converter 214, is maintained during the entire 360° rotation of converter 214. Compare this to a traditional connecting rod and crank configuration of an internal combustion engine, where an effective 90° maximum leverage angle between a piston's reciprocating motion and the crank only occurs at a single point during a power stroke. Further, this single instant where maximum leverage exists in a connecting rod and crank configuration does not occur when the combustion forces within the cylinder are at their greatest (i.e., at top dead center). Rather, by the time the maximum effective leverage angle is reached, the combustion forces have considerably decreased due to the expansion in volume and cooling of the combustion gases. Typically, in a connecting rod and crank configuration, the maximum effective leverage angle is not reached until after the piston has traveled 40% of its stroke from top dead center.

On the other hand, internal combustion engines incorporating systems 200 (depending on the particular shape of undulating track used) may reach maximum effective leverage at the instant of maximum combustion pressure, within 1% of the piston's stroke from the top dead center position, within 2% of the piston's stroke, within 3% of the piston's stroke, within 4% of the piston's stroke, within 5% of the piston's stroke, within 10% of the piston's stroke, within between about 1% and 5% of the piston's stroke, or within another percentage of the piston's stroke depending on the particular configuration of system 200 used.

The above principles equally apply to compressed-air engines incorporating systems according to the present disclosure. In compressed-air engines, the pressure of air injected into a cylinder, like the combustion gases of an internal combustion engine, also decreases as the piston reciprocates due to expansion in volume of the injected air.

In some instances, by simply replacing the standard connecting rod crank configuration with a system 200, an engine's power may be increased by 25%, by 50%, by 100%, by 200%, by between 25% and 50%, by between 50% and 100%, by between 100% and 200%, or by even greater than 200%, 500%, or even 800%.

Additionally or alternatively, in some instances, by simply replacing the standard connecting rod crank configuration with a system 200, an engine's torque may be increased by 25%, by 50%, by 100%, by 200%, by between 25% and 50%, by between 50% and 100%, by between 100% and 200%, or by even greater than 200%, 500%, or even 800%.

Additionally or alternatively, in some instances, by simply replacing the standard connecting rod crank configuration with a system 200, an engine's efficiency may be increased by 25%, by 50%, by 100%, by 200%, by between 25% and 50%, by between 50% and 100%, by between 100% and 200%, or by even greater than 200%, 500%, or even 800%.

Other additional benefits of incorporating a system 200 into an internal combustion engine may include: longer effective piston stroke and greater combustion ratios; less thermal loss and cooler exhaust due to more room for gas expansion; less piston friction due to balanced piston rod versus a crankshaft offsetting pressure on a connecting rod and piston assembly; less RPMs required resulting in less friction and less thermal and energy losses due to catching up to a slower receding piston; the ability to adjust the diameter and shape of the undulating track for specific torque requirements; more consistent power band and the ability to run leaner fuel.

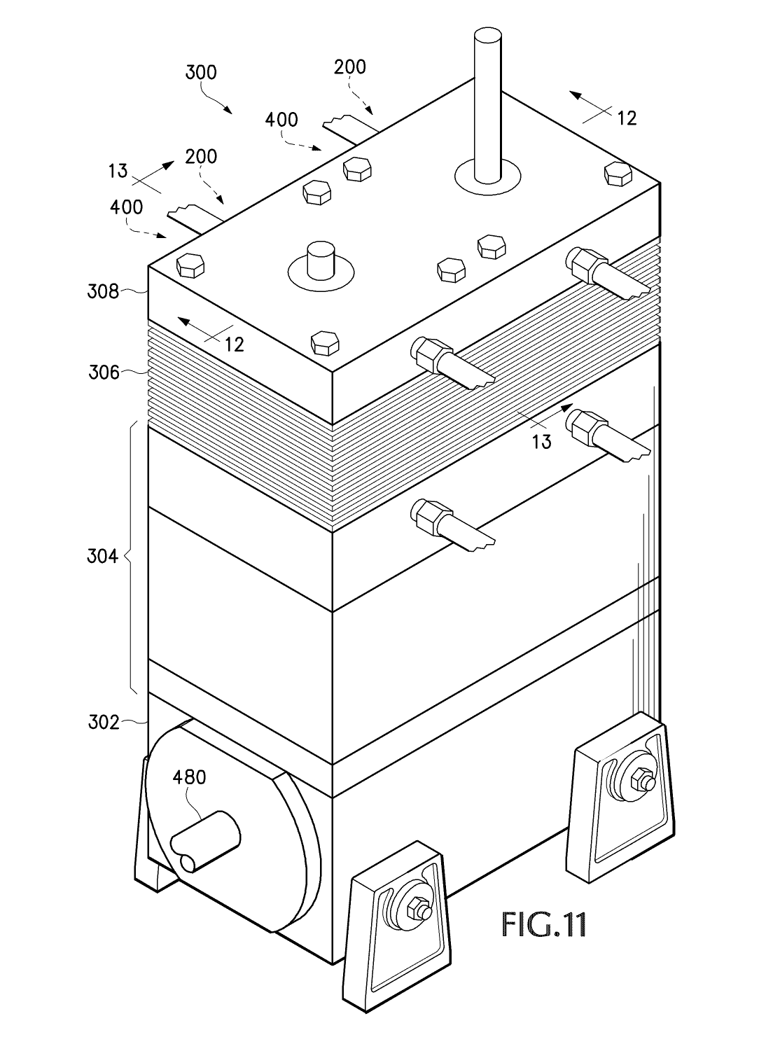

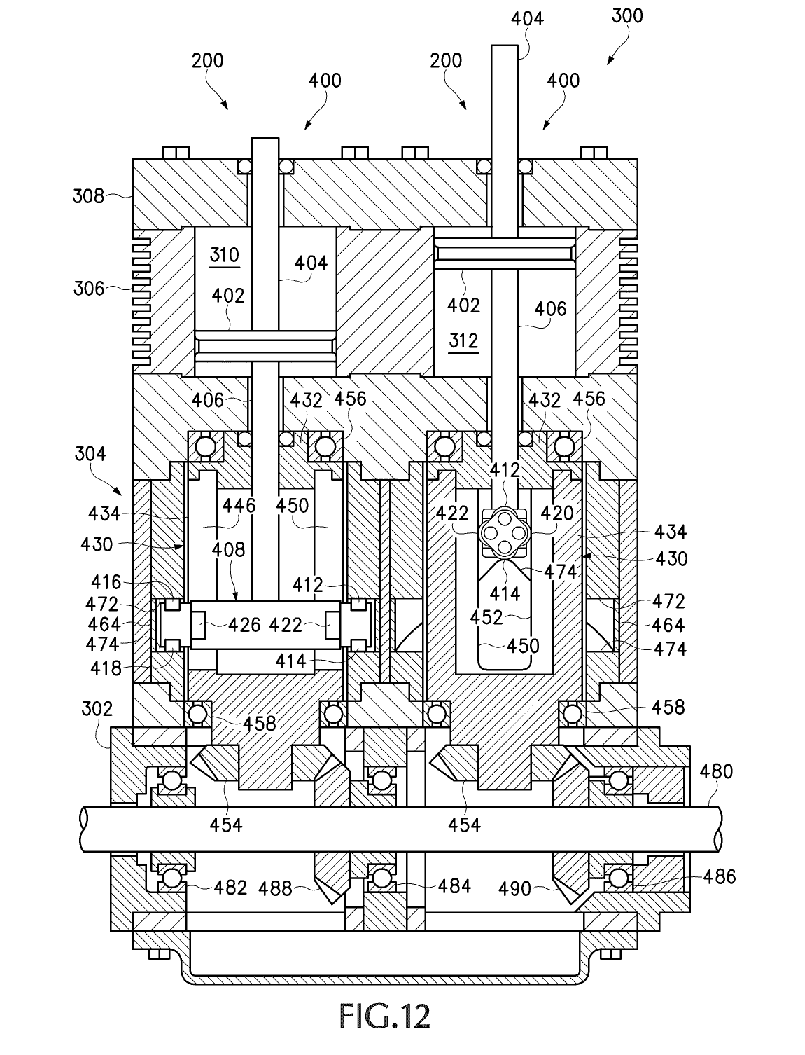

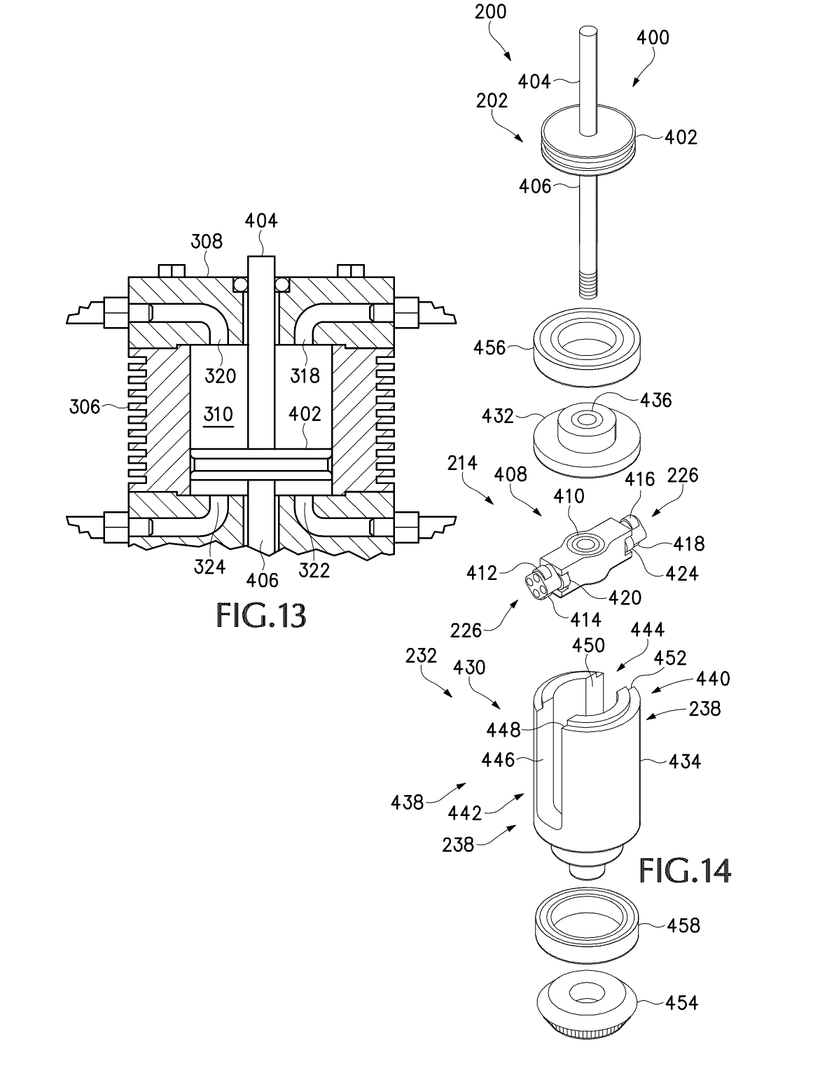

FIGS. 11-16 illustrate a non-exclusive example of a two-cylinder compressed-air engine 300, and portions thereof, incorporating two non-exclusive examples of systems 200 and generally indicated at 400. As best seen in FIGS. 11 and 12, engine 300 includes an output-shaft case 302, a conversion block 304, a cylinder block 306, and a cylinder head 308. Such structural components as well as other components described herein may be made of aluminum, steel, or any other material appropriate for a particular configuration and/or application of an engine 300. Any number of cylinders may be incorporated into engines according to the present disclosure, and engines are not limited to including only two cylinders.

The two systems 400 incorporated into engine 300 are identical, and therefore like reference numerals are used with respect to each component thereof; however, engines according to the present disclosure are not required to incorporate identical systems 200 when more than one system is included.

Engine 300 includes a first cylinder 310 and a second cylinder 312, and as shown in FIG. 10, each cylinder includes an upper inlet 318, an upper outlet 320, a lower inlet 322, and a lower outlet 324. Valving (not shown) provides for the delivery and exhaustion of compressed air to and from the cylinder. A non-exclusive example of an inlet valve that may be used with engine 300 is a Parker Schrader Bellows part no. N31461089. A non-exclusive example of an exhaust valve that may be used with engine 300 is a Parker Schrader Bellows valve no. N37471089. The inlet and exhaust valves may be controlled by separate pilot valves. A non-exclusive example of a pilot valve that may be used with engine 300 is a KIP Inc. solenoid valve no. V351046. The pilot valve may be controlled by a computer to appropriately time the delivery and exhaustion of compressed air to and from the cylinders on respective sides of the pistons.

A system 400 includes a piston 402 having a first piston rod 404 coupled to the top side of the piston (when viewed from the perspective of the accompanying figures) and a second piston rod 406 coupled to the bottom side of the piston. One of—or a combination of—the piston and the piston rods may be described as a reciprocator 202 of a system 200. Though not required, the first piston rod 404 is provided so that the surface area on one side of a piston is equal to the surface area on the opposite side of the piston. Accordingly, when a given pressure of compressed air is delivered above a first piston in a first cylinder and below a second piston in a second cylinder, the same force will be generated on both pistons.

Second piston rod 406 is coupled to a non-exclusive example of a converter 214 indicated at 408. Converter 408 includes a bearing 410 so that converter 408 may rotate relative to second piston rod 406. Accordingly, as the piston and the converter reciprocate together, the piston will not be forced to rotate within the cylinder as the converter rotates.

Converter 408 includes two portions 226, each in the form of a pair of rollers: a first roller 412 in rolling contact with a second roller 414, and a third roller 416 in rolling contact with a fourth roller 418. These two pairs of rollers are further in rolling contact with the continuous undulating track 220 discussed in more detail below.

Converter 408 further includes two portions 241, each in the form of a pair of rollers: a fifth roller 420 in rolling contact with a sixth roller 422, and a seventh roller 424 in rolling contact with an eighth roller 426. These two pairs of rollers are further in rolling contact with the tracks 238 of rotator 232 discussed in more detail below.

System 400 further includes a non-exclusive example of a rotator 232, indicated at 430. Rotator 430 is generally cylindrical and includes a top disc-shaped portion 432 press-fit onto a main portion 434. A first passage 436 is provided in the disc-shaped portion and through which second piston rod 406 extends. A second passage 438 and a third passage 440 are provided in the main portion and through which converter 408 extends. Passages 438, 440 define tracks 238 in the form of a first linear track 442 and a second linear track 444. First linear track 442 is further defined by a first surface 446 and a second surface 448 opposing and spaced from first surface 446. Second linear track 444 is further defined by a first surface 450 and a second surface 452 opposing and spaced from first surface 450.

Fifth and sixth rollers 420, 422 of converter 408 are in rolling contact with first and second surfaces 446, 448 of first linear track 442, respectively, and seventh and eighth rollers 424, 426 of converter 408 are in rolling contact with first and second surfaces 450, 452 of second linear track 444, respectively.

Rotator 430 further includes a 45 degree miter gear 454 secured to the lower portion thereof.

Rotator 430 is rotationally coupled to the converter block 304 (seen in FIG. 12) by a top bearing 456 and a bottom bearing 458.

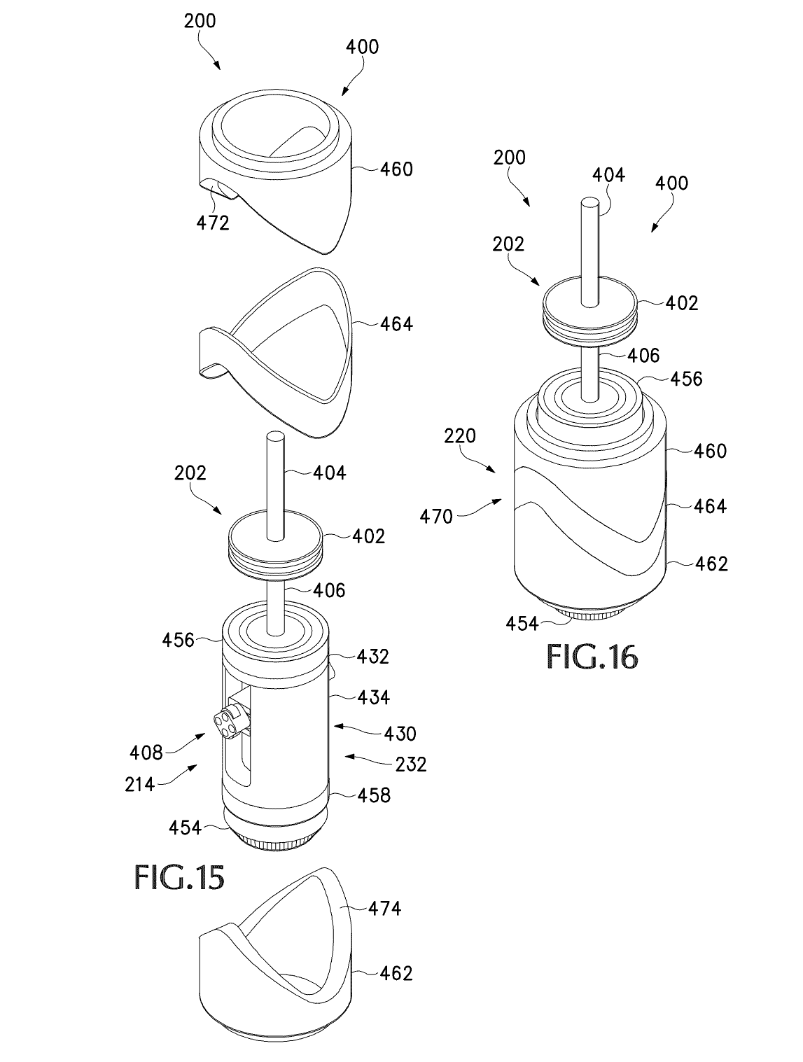

Referring to FIGS. 15 and 16, system 400 further includes a first track portion 460 and a second track portion 462 spaced from the first track portion by a spacer 464. The first and second track portions thereby define a non-exclusive example of a continuous undulating track 220, indicated at 470. First track portion 460 includes a first track surface 472, and second track portion 462 includes a second track surface 474. Accordingly, track 470 may be described as being defined by first track surface 472 and second track surface 474 opposing and spaced from first track surface 472. Although track 470 is illustrated as having two cycles of equal wavelength and amplitude, other configurations of tracks 220 may be incorporated into systems 400.

Track 470 may be described as circumscribing a circular profile and generally defining a cylindrical volume having a central axis. Rotator 430 may be described as being positioned within the cylindrical volume. Converter 408 may be described as being positioned at least partially within rotator 430.

Referring back to FIG. 12, an output shaft 480 is rotationally supported in output-shaft case 302 by a series of bearings 482, 484, 486. Coupled to the output shaft is a pair of 45 degree miter gears 488, 490 that are engaged with miter gears 454 of systems 400. Accordingly, the rotational motion of rotator 430 is translated 90 degrees to the rotational motion of the output shaft. Output shaft 480 may be coupled to any appropriate system desired. For example, an engine 300 may be incorporated into a vehicle, into an electric power plant, or into any suitable system where rotational motion is a desired output. Output shaft 480 may be described as a non-exclusive example of a rotating element 204.

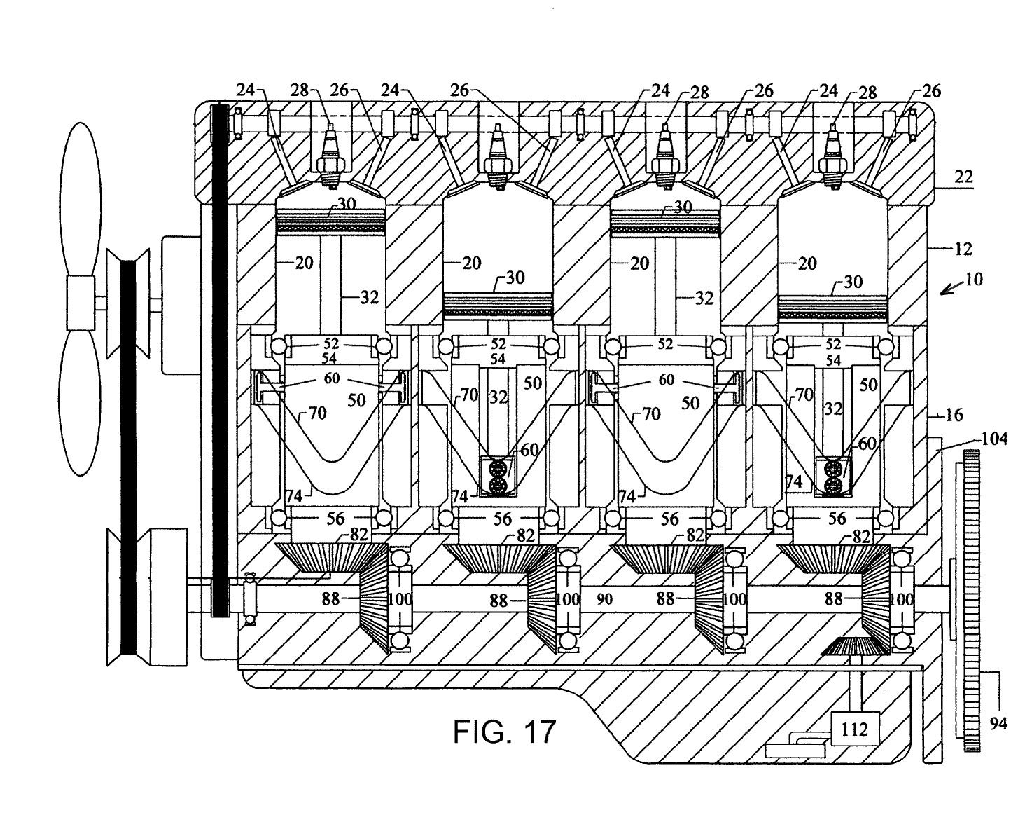

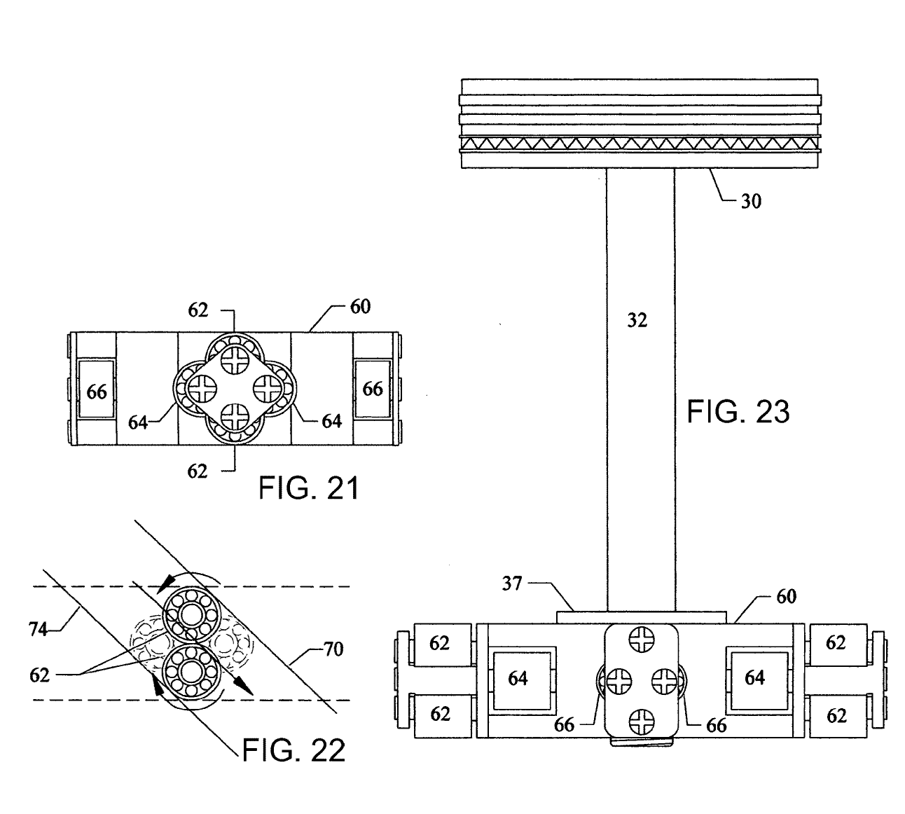

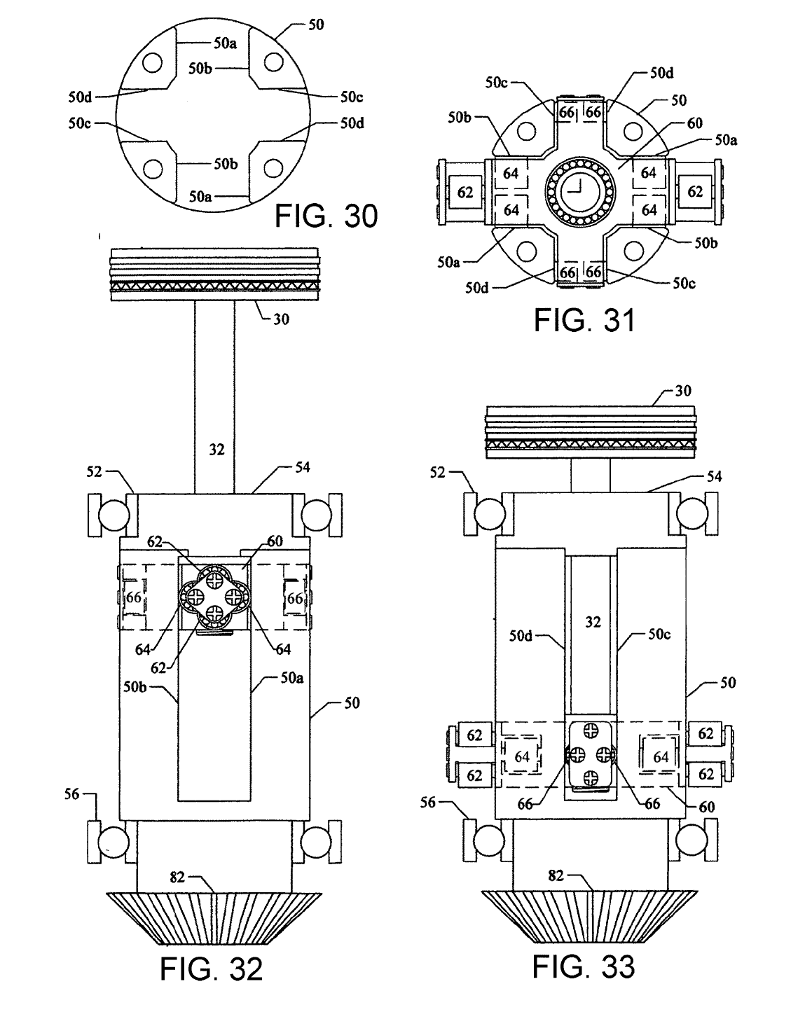

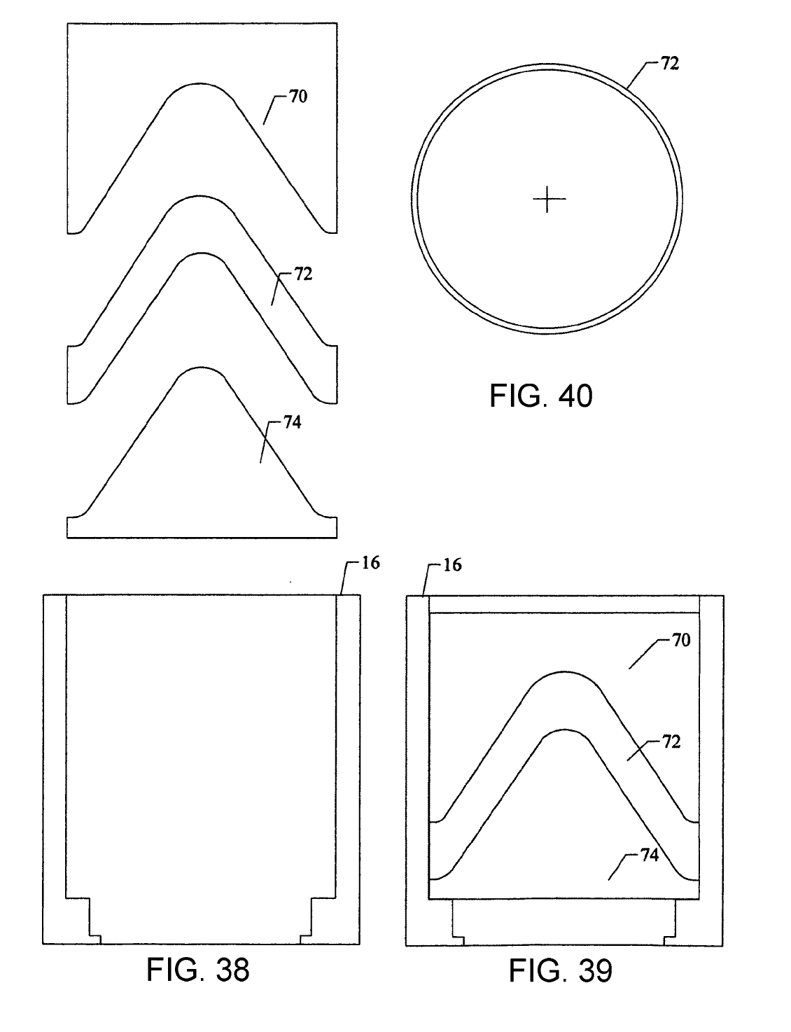

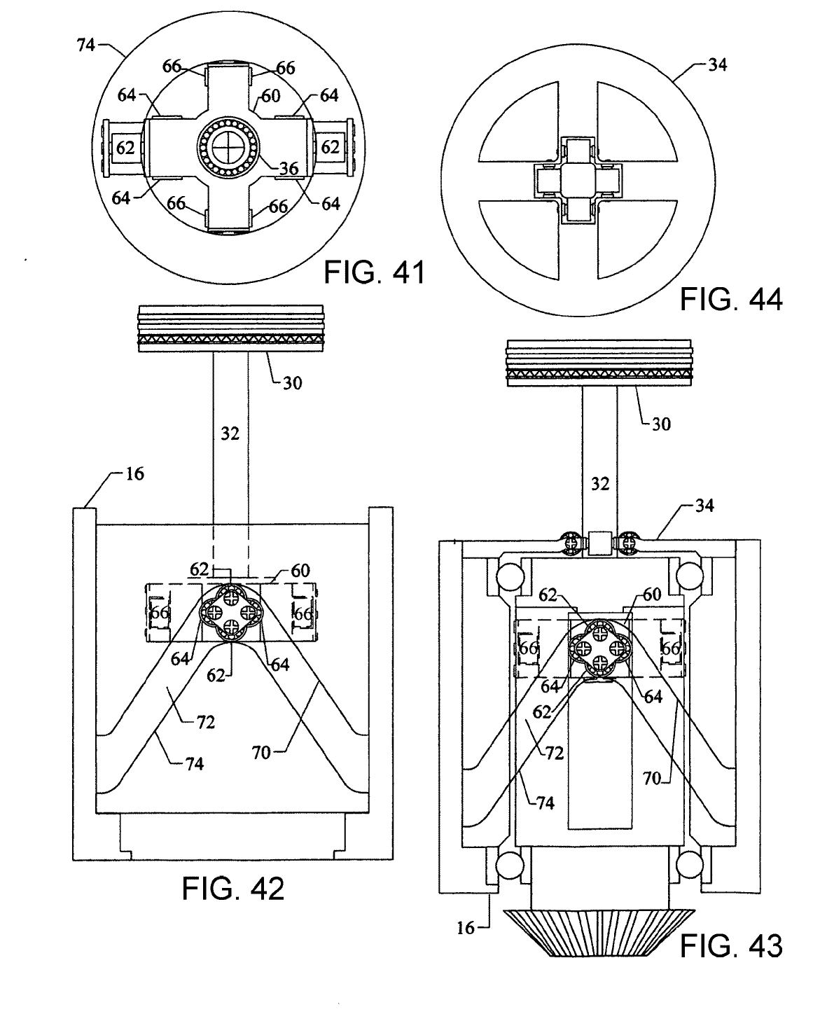

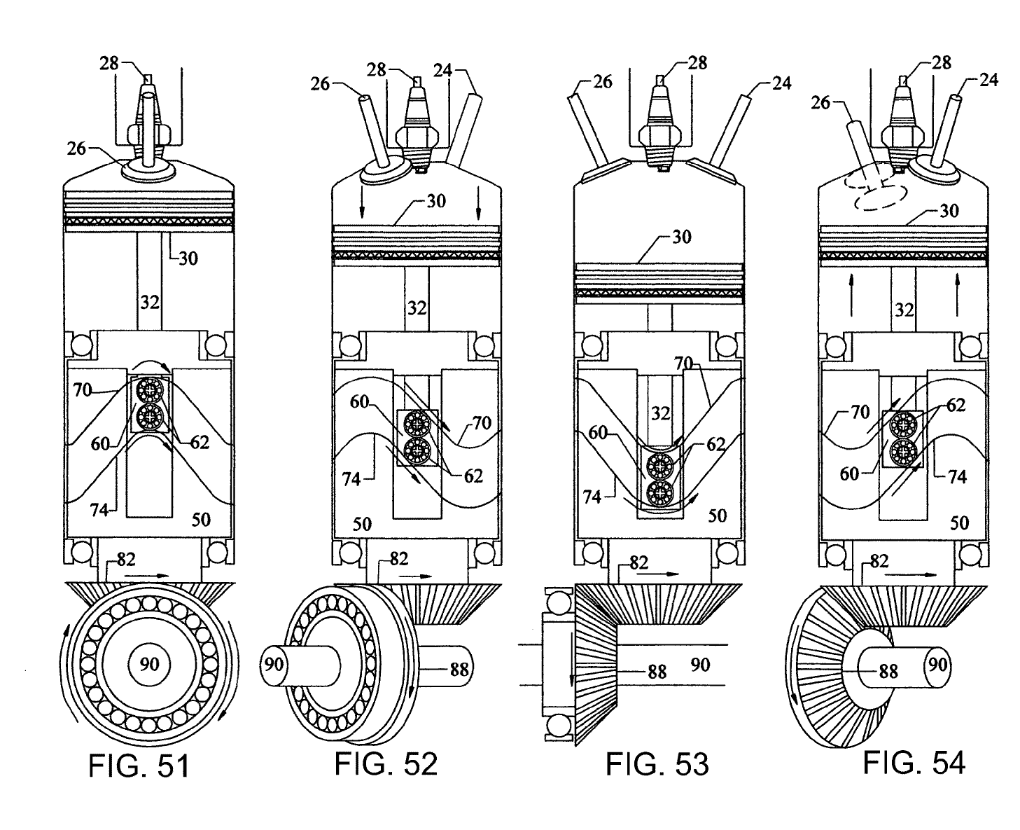

Referring to FIGS. 17-54, a non-exclusive example of an internal combustion engine may include a block 10, which is composed of a cylinder block 12, interchanger block 16, and crankcase 104, having bores defined by cylinders 20, cylinder head 22, intake means 24, ignition means 28, exhaust means 26, pistons 30, wave races 70 (upper) and 74 (lower), converters or interchanger units 60, rotators or rotating carriers 50, driver and driven gears 82 and 88, crankshaft 90, lubrication means 112 and various working and support bearings 52, 56 and 100.

Pistons 30 may be described as non-exclusive examples of a reciprocator 202. Interchanger units 60 may be described as non-exclusive examples of a converter 214. Rotating carriers 50 may be described as non-exclusive examples of a rotator 232. Wave races 70, 74 may be described as non-exclusive examples of first and second surfaces 230, 270 that define a continuous undulating track 220.

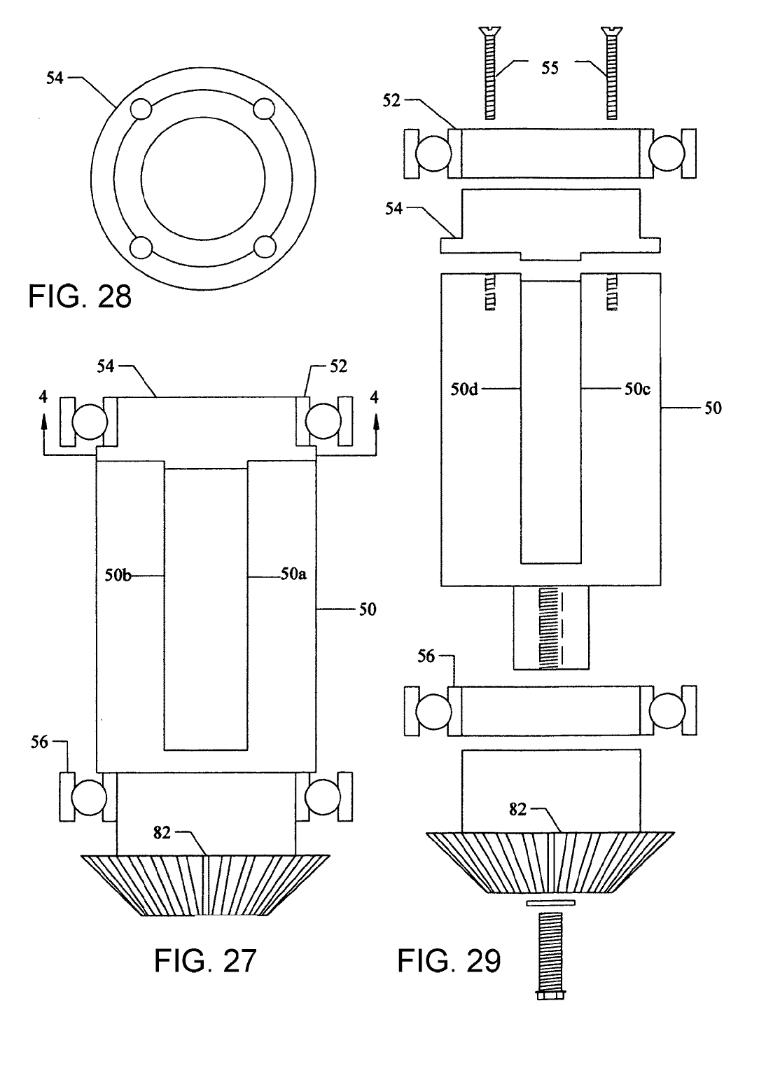

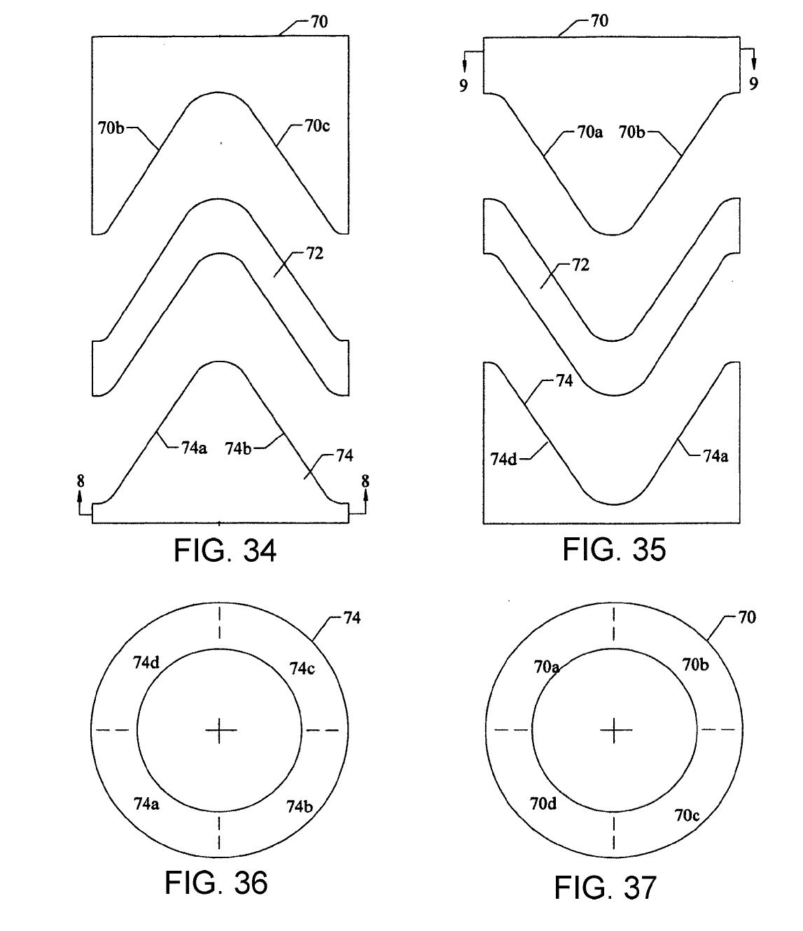

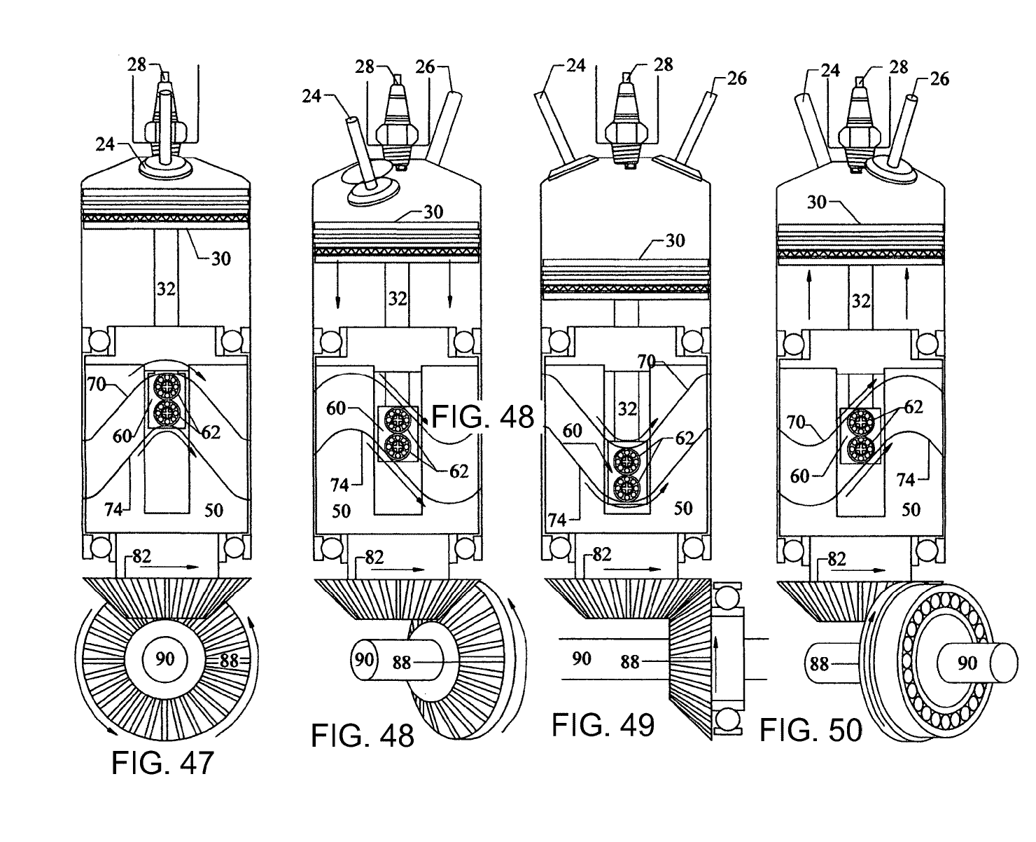

In the embodiment illustrated, the rotating assembly (which may be described as a non-exclusive example of a system 200) as shown in FIG. 43, may include three main components functioning together: a converter or interchanger unit 60, as shown in FIGS. 20, 21, and 23, having track rollers 62, which ride between two wave shaped races 70 and 74 that are parts of a stationary mounted cylindrical unit as shown in FIG. 39. The third component is a rotator or rotating carrier unit 50, mounted on bearings 52 and 56, with the top bearing 52, mounted on a support 54, that may also add stability to the carrier, as shown in FIG. 27, in which the interchanger 60 rides up and down to keep the interchanger 60 centered by means of centering rollers 66, riding on the carrier tracks 50c and 50d as seen in FIGS. 29-31, to maintain correct orientation of the track rollers 62, on the races 70 and 74. The carrier 50 may also transfer the converted rotational motion from the interchanger 60 by means of the power transfer rollers 64, riding on the carrier tracks 50a and 50b as shown in FIGS. 27, 30, and 31, to the output shaft 90, via gears 82 and 88 as shown in FIGS. 17, 27, 29, 43 and 47-54. Referring to FIGS. 47-54, which are illustrations of the engine through the four cycles of an Otto cycle or Diesel cycle engine from beginning to end starting with the piston 30, ready to begin the intake cycle, then continuing through the compression cycle, combustion cycle and ending with the exhaust cycle. FIGS. 47-54 show the movement of the track rollers 62 as they traverse up and down the slopes 74a, 74b, 74c, 74d and 70a, 70b, 70c, 70c of the wave races 74 and 70, as also shown in FIGS. 34-37.

The converter or interchanger 60 is so named because it converts reciprocating motion into rotational motion during the combustion cycle and then converts rotational motion to reciprocating motion during the intake, compression and exhaust cycles. The conversion from reciprocating motion to rotational motion is accomplished during the combustion stroke when the rollers 62 are forced at the same time down the declining slopes 1b and 2b, as shown in FIG. 37, causing a downward spiraling motion. Because the faces of the slopes 2b and 2b are of a 45 degree decline (after a short radius at the top), the downward pressure from the piston 30 may be converted to rotational motion at a one to one ratio. This means that for every inch the piston 30, moves down, the interchanger will rotate an inch, therefore converting the reciprocating motion of the piston 30 into rotational motion at a 90 degree angle to the axis of the interchanger and therefore achieve an optimal transfer of energy. The rotating carrier as seen in FIG. 28 may then transfer the converted rotational motion to the output shaft 90, through the driver and driven gears 82 and 88, when the power transfer rollers 64, and interchange centering rollers 66, as seen in FIGS. 22-24, ride up and down the races 50a, 50b, 50c and 50d, of the carrier 50, while under the pressure created by the interchanger 60, as they follow the contours of the races 70 and 74.

The piston 30, is returned to the cylinder top (Top dead center) and through the remaining three strokes of the combustion cycle either by centrifugal force from the flywheel 94, as seen in FIG. 17, attached to the output shaft 90, or the power from other pistons connected to the same output shaft 90. A flywheel 94 may also be used to ensure smooth rotation.

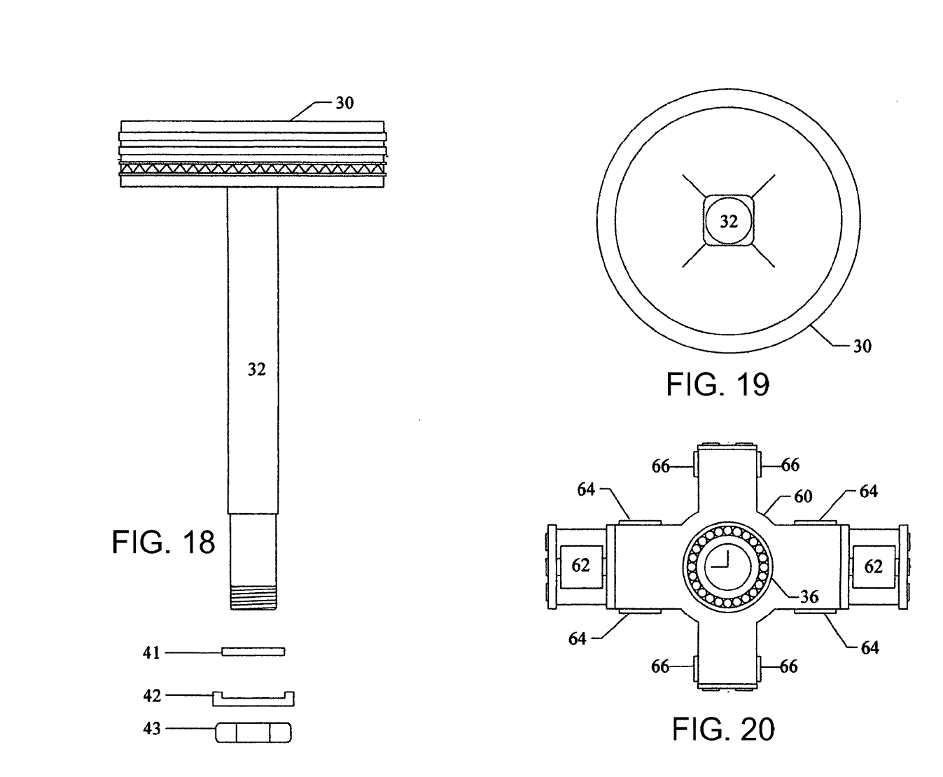

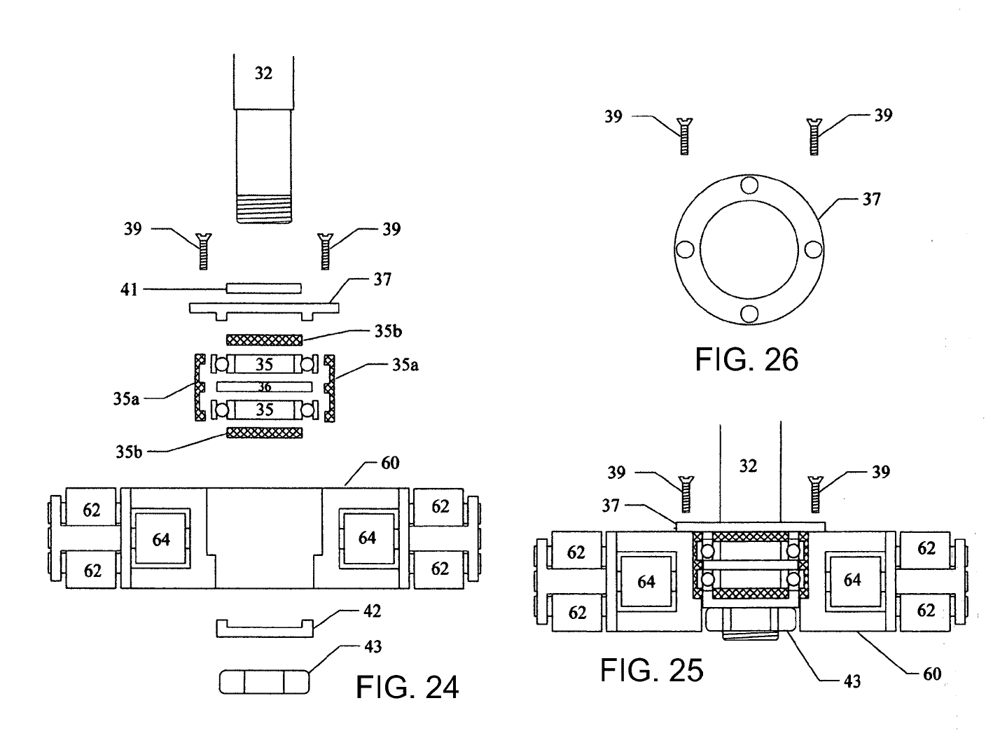

To help insure the performance and service life of the engine, the piston 30 may be held from spinning inside the cylinder 20 by means of a stabilizer unit 34, as seen in FIGS. 43 and 43. The stabilizer unit 34 keeps the piston from spinning by means of four rollers that stay in contact with the four sides of the connecting rod 32, as shown in FIGS. 18 and 19. The piston 30 and connecting rod 32 are able to be restrained from spinning because they are attached to the interchanger 60 by means of thrust bearings 35, as seen in FIGS. 24 and 26. Also referring to FIGS. 18, 24, and 25, the retaining nut 43 and washers 41 and 42, thrust bearing retainer 37, and screws 39, as seen in FIGS. 25 and 26, may also retain shock dampeners 35a and 35b that help shield the thrust bearings 35 from shock created from combustion to the piston 30, or inertia during higher speeds of the engine as the track rollers 62 reach the top and bottom radiuses of the races 70 and 74.

Referring to FIG. 22, the track rollers may be mounted in such a manner as to keep them in contact with each other. This contact may keep them always spinning at the correct speed and direction as they ride on the races 70 and 74. The spacer 72, as seen in FIGS. 39 and 40 keeps the races 70 and 74 at the correct distance from each other to maintain close tolerance to the track rollers 62, but as the track rollers 62 follow the contours of the races 70 and 74, contact will fluctuate between the races, so to keep the track rollers 62 from skidding on the races or have to change in rotational direction, they are always kept spinning the correct direction and speed by always being in contact with the other roller. The track rollers 62 always being in contact with each other may also allow the load subjected to one roller to be shared by both, which may reduce the load that any one roller will have to bear on its own, which may extend the service life of both rollers. The track rollers 62 and races 70 and 74 may be substituted for other means of accomplishing the same functions such as magnets, hydraulics, pressurized air or any other means that will facilitate a similar type working relationship that will yield the same results. The rotating assembly may also be configured to where the interchanger and carrier are mounted stationary with the races rotating around them or any other configuration that yields the same results.

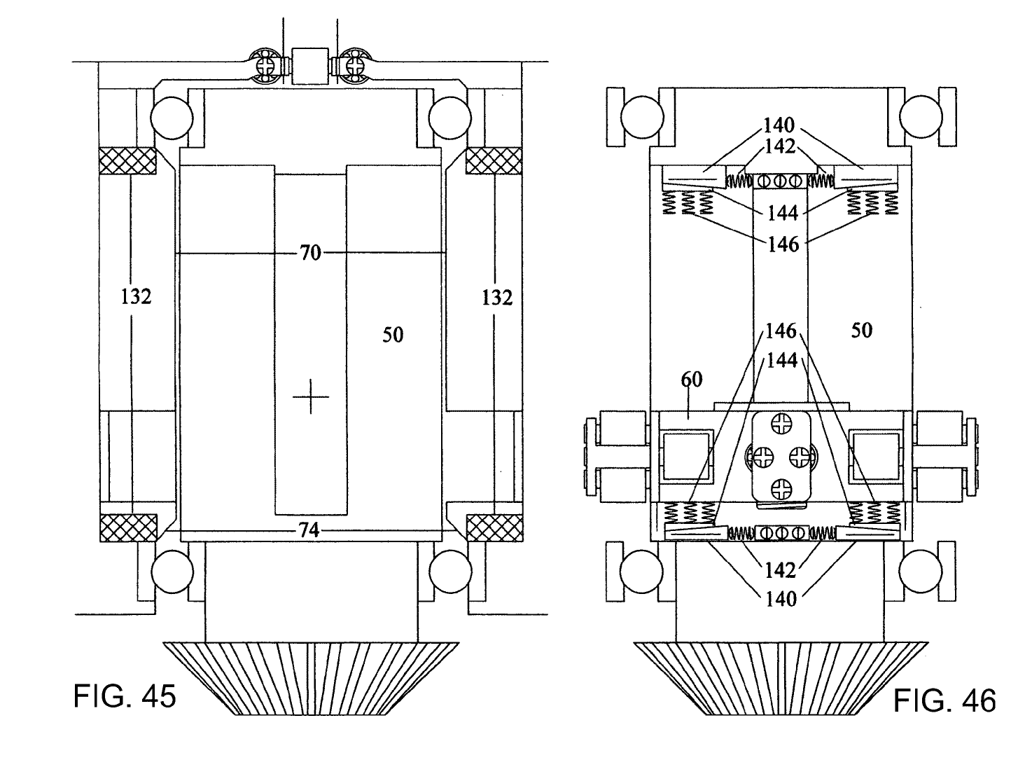

Referring to FIG. 45, the races 70 and 74, are shown mounted on shock absorbing dampeners 132. These dampeners are installed to absorb and release shock created from combustion to the piston 30 or inertia during higher speeds of the engine as the track rollers 62 reach the top and bottom radiuses of the races 70 and 74. These dampeners 132 may be made of high density rubber or polyurethane type materials that offer a higher load-bearing capacity than rubber with more resistance to oils and chemicals found on the inside of an engine. This same rubber or polyurethane type materials may also be used in the shock dampeners 35a and 35b as seen in FIG. 24. Springs, conical washers, fluid, air or any other means may be substituted for the rubber or polyurethane dampeners 35a, 35b and 132.

Referring to FIG. 46, a reciprocator system is shown installed in the carrier 50, which may be operated by centrifugal force. As the speed (RPMs) of the engine increases, the inclined centrifugal weights 140, may overcome the resistance of the centrifugal weight springs 142, allowing the weights to move outward from the center of the carrier 50. The resulting movement may cause the reciprocator spring inclines 144 to move up and create more pressure on the reciprocator springs 146, therefore creating a speed sensitive mechanical means of absorbing the increasing amount of energy at the end of each stroke created by inertia as the speed (RPMs) of the engine increases, then releasing that energy back after the track rollers 62 pass the upper and lower radiuses of the races 70 and 74, therefore helping facilitate the reciprocating motion of the piston 30, connecting rod 32, and interchanger unit 60, for the purpose of increasing the performance, service life and dependability of the engine by reducing stress to the track rollers 62, interchanger unit 60, and races 70 and 74. This mechanical reciprocator system may be substituted for a different type of system that utilizes pressurized fluids, compressed air, magnets or other means to accomplish the same speed sensitive absorbing and releasing of energy process.

The materials to be used in the overall construction of the engines may include aluminum, steel, rubber, plastics, automotive type gaskets and most any other materials commonly used in the manufacture of engines. Materials such as ceramics or specialty metals may be used in certain areas such as the combustion chambers, rotating assemblies, etc. The materials to be used in the rotating assembly may generally be of high-grade steel or similar materials because they are subjected to high pressures and impact. A softer surface may be applied to the tracks 70 and 74, such as high-density rubber or polyurethane type materials to help reduce shock loads to the track rollers 62.

Many additional parts and functions of the nonexclusive illustrative examples of engine disclosed herein, as well as their overall construction, were not discussed in detail because the nature of many parts, designs, functions and construction of these engines may not differ, or may differ relatively little from designs, and technology already well known and used for many years and therefore may be considered common knowledge and standard practice in the field of reciprocating engines. Some of these features, parts and/or functions may include, but are not limited to, fuel delivery systems, lubrication systems, ignition systems, cooling systems, compression ratios, combustion chamber sealing, high performance modifications, supercharging, turbocharging, manufacturing procedures, materials of manufacture, maintenance, means for attaching this engine to machinery or transmission, and the like. Remaining close to current engine designs, materials of manufacture, and manufacturing may allow these engines to be reproduced more readily and may also make it easier for consumers to understand, maintain and operate.

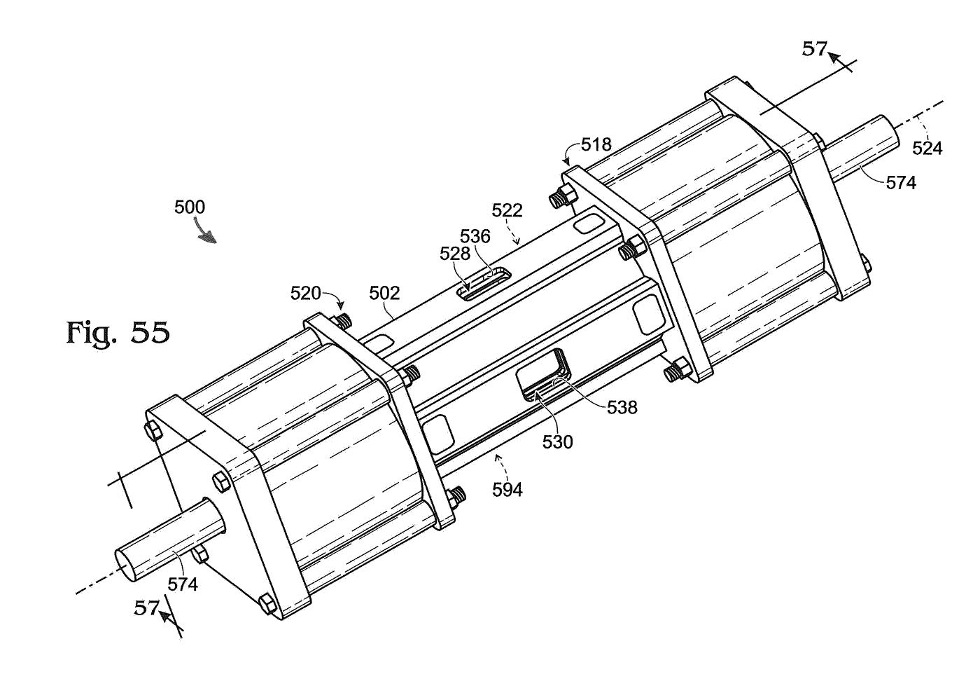

Another nonexclusive illustrative example of an engine is shown generally at 500 in FIGS. 55-58. Unless otherwise specified, engine 500 and its various component parts may, but are not required to, contain at least one of the structures, components, functionalities, concepts, and/or variations described, illustrated, and/or incorporated herein. The engine 500 may include a case or body 502, a rotating cylinder 504, at least one piston 506, at least one undulating circumferential track 508, and a converter 510. In some examples, the engine 500 may include a liner 512 and/or a rotator 514. The engine 500 may additionally include various accessories and components as are known in the art for use with reciprocating engines.

The body 502 may extend between first and second ends 518, 520 and have a cylindrical chamber or interior 522 defining an axis 524 about which the undulating circumferential track 508 extends. The body may include at least one inlet opening 528 and at least one exhaust opening 530 that open into the cylindrical interior 522. As generally shown and suggested in FIGS. 55-58, the engine may include a plurality of inlet openings 528 and exhaust openings 530, that may be linked via respective manifolds or plenums 532, 534 to respective inlet and exhaust ports 536, 538 on the exterior of the body.

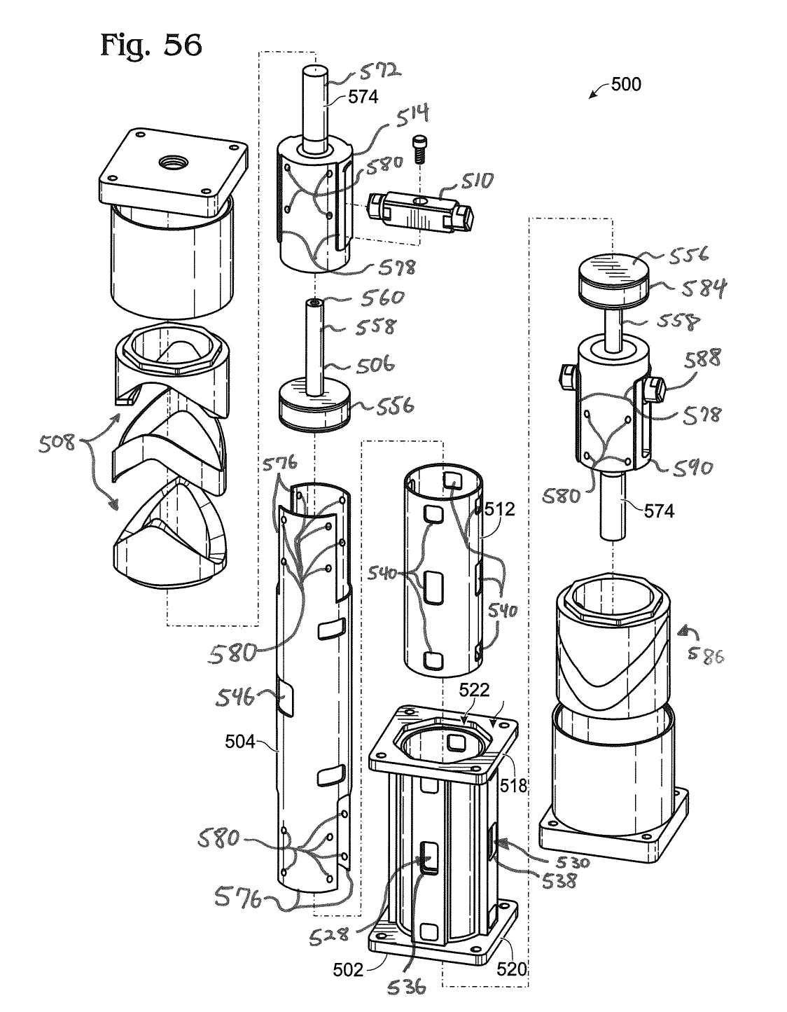

The liner 512 may be mounted within the cylindrical interior 522, as generally shown in FIGS. 56-58. As shown in FIG. 56, the liner 512 may include a plurality of openings 540 corresponding to the inlet openings 528 and exhaust openings 530 on the body 502.

The liner 512 may be fabricated from or comprise a material selected to reduce friction between the liner and the rotating cylinder. For example, in the case of non-internal combustion engines, such as those powered by compressed air, the liner 512 may be fabricated from a suitable material, such as a molybdenum disulphide filled or impregnated nylon, such as the materials available under the Nylatron® mark from Quadrant Engineering Plastic Products of Reading, Pa. Other suitable materials for the liner 512, may include other filled plastics, such as plastics filled or impregnated with PTFE (polytetrafluoroethylene), which is available from DuPont under the Teflon® mark. When used in an internal combustion engine, the liner 512 may be fabricated from a suitable material such as a ceramic or a ceramic composite. Nonexclusive illustrative examples of suitable ceramics may include silicon nitride and aluminum oxide.

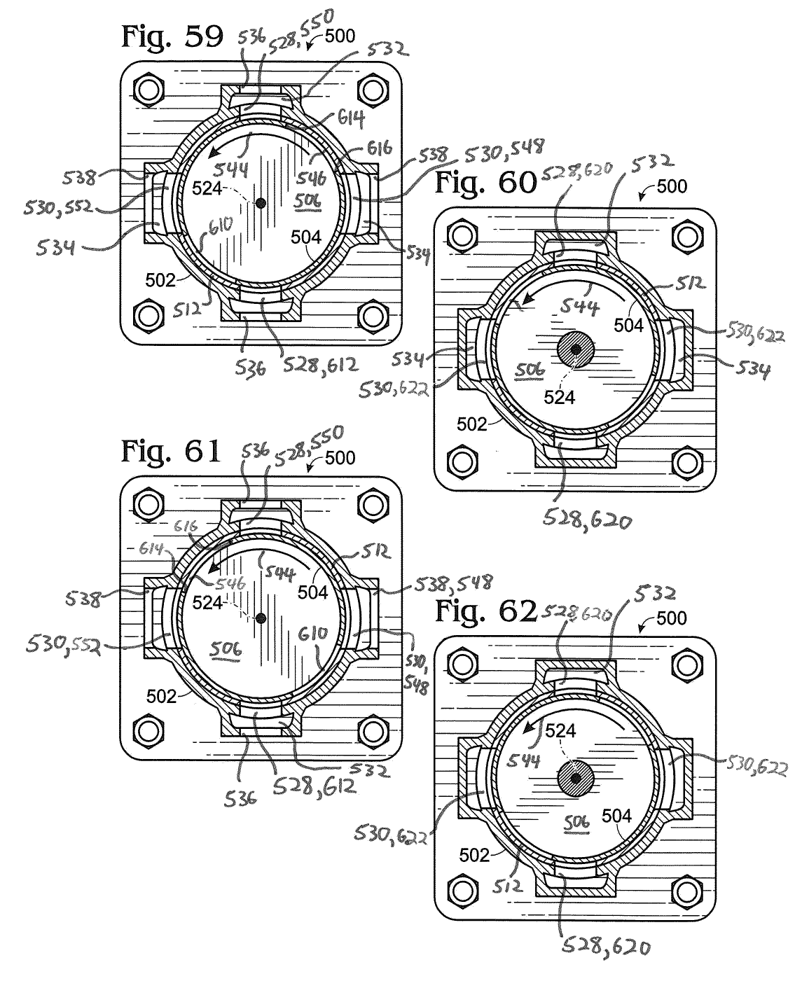

The rotating cylinder 504 may be disposed within the cylindrical interior 522 of the body 502 and configured for rotation about the axis 524 and relative to the body, as suggested by the arrow 544 in FIGS. 59-62. When the engine 500 includes a liner 512, as shown in FIGS. 56-58, the rotating cylinder 504 may be disposed within the liner 512 and configured for rotation about the axis 524 and relative to the liner and the body.

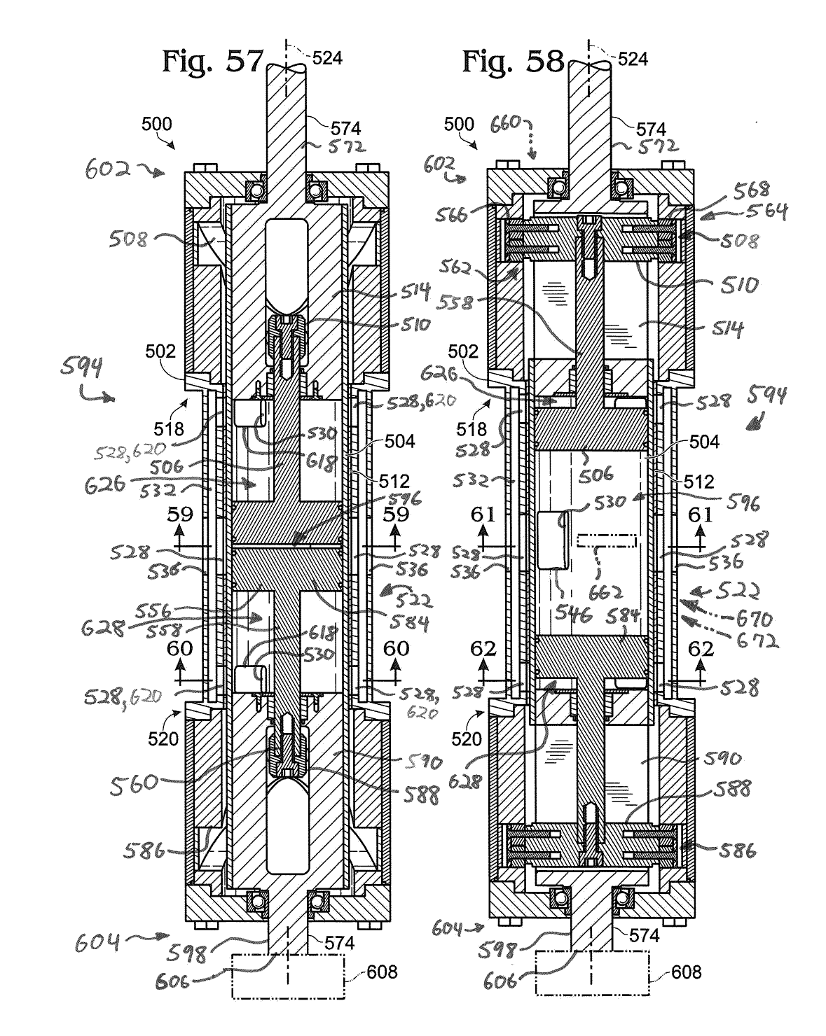

As generally shown in FIGS. 56-58, the rotating cylinder 504 may include at least one port 546 that is axially aligned with the inlet and exhaust openings 528, 530 on the body 502. The port 546 may be sequentially aligned with the inlet and exhaust openings 528, 530 on the body 502 as the rotating cylinder 504 rotates about the axis 524 within the cylindrical interior 522 of the body. For example, as shown in FIG. 59, which shows the engine 500 with the piston in the top dead center position illustrated in FIG. 57, the port 546 may be positioned between a first exhaust opening 548 and a first inlet opening 550. After ninety degrees of rotation of the rotating cylinder 504, as shown in FIG. 61, which shows the engine 500 with the piston in the bottom dead center position illustrated in FIG. 58, the port 546 may be positioned between the first inlet opening 550 and a second exhaust opening 552.

The rotating cylinder 504 may fit within the cylindrical interior 522, or the liner 512, if present, sufficiently closely that the port 546 may effectively be sealed by the cylindrical interior or the liner when the port is not aligned with any of the inlet and exhaust openings. A sufficiently close fit between the rotating cylinder 504 may provide sufficient sealing to the cylindrical interior 522 or liner 512 while permitting free rotation between the rotating cylinder and the cylindrical interior or liner. In some examples, localized seals may be provided on the rotating cylinder and/or the liner or the cylindrical interior of the body proximate the port and/or the inlet and exhaust openings. Such localized seals may be in addition to or an alternative for sealing based on a close fit between the rotating cylinder and the cylindrical interior or liner.

A relatively close fit between the cylindrical interior or the liner and the rotating cylinder may provide radial support to the rotating cylinder, such as to resist radial expansion and/or growth of the rotating cylinder during operation. For example, as may be understood from FIGS. 57 and 58, the relatively close fit between the liner 512 and the rotating cylinder 504 may permit the liner 512 to radially support the portion or portions of the rotating cylinder 504 within which the pistons reciprocate.

As shown in FIGS. 56-58, the piston or pistons 506 may be disposed within the rotating cylinder 504 and configured for reciprocating motion along the axis 524. The piston 506 may include a piston head 556 and a piston shaft 558 extending along the axis from the piston head to a distal end 560. As shown in FIG. 56, the converter 510 may be removably mounted to the distal end 560 of the piston shaft 558.

The converter 510, when mounted to the piston 506, may be engaged with the undulating circumferential track 508 and configured to reciprocate with the piston 506. As generally discussed above, the track 508 may cause the converter 510 to rotate about the axis 524 as the piston and converter reciprocate along the axis. In some examples, the piston 506 may rotate about the axis 524 with the converter 510 as the converter and piston reciprocate along the axis. In some examples, as will be more fully discussed below, the rotating cylinder may rotate with the converter and the piston, as the converter and piston reciprocate along the axis, such that there is no relative rotation between the rotating cylinder and the converter and piston.

In some examples, the converter 510 may extend from a first end to a second end. As shown in FIG. 58, the first end 562 of the converter 510 may engage a first part 566 of the undulating circumferential track 508, while the second end 564 of the converter 510 engages a second part 568 of the undulating circumferential track 508 opposite the first part.

As noted above, some examples of the engine 500 may include a rotator 514 configured to rotate about the axis 524. As shown in FIGS. 56-58, the rotator 514 may include an output 572 and be engaged with the converter 510 such that rotation of the converter about the axis 524 causes the rotator to rotate about the axis. The engagement between the converter and the rotator, which allows for axial relative movement of the rotator and converter, may include bearings as discussed above, or the rotator and converter may include cooperating lubricated sliding surfaces.

The output 572 may be or include any suitable structure that may be configured to transmit power and torque from the engine. For example, as shown in FIGS. 55-58, the output 572 may include a shaft portion or stub shaft 574 extending from the rotator 514. As shown in the example of FIGS. 56-58, the undulating circumferential track 508 may generally be disposed between the piston 506 and the output 572.

As shown in the example presented in FIG. 56, the rotator 514 and rotating cylinder 504 may be cooperatively configured such that the rotator 514 may be engaged with the rotating cylinder 504 such that rotation of the rotator about the axis 524 causes the rotating cylinder to rotate about the axis. In particular, the rotating cylinder 504 may include extensions or ears 576 that may be engaged with corresponding projections or edges 578 on the rotator 514 to prevent relative rotation between the rotating cylinder 504 and the rotator 514. The rotator 514 and rotating cylinder 504 may be further secured relative to each other by way of a plurality of fasteners installed at the corresponding locations 580 on the rotator and rotating cylinder, as suggested in FIG. 56. Nonexclusive illustrative example of suitable fasteners may include screws, rivets, pins, or the like. Other nonexclusive illustrative examples of possible methods for retaining the rotating cylinder to the rotator may include staking, welding, or the like.

As shown in FIGS. 56-58, some examples of the engine 500 may include a second piston 584, a second undulating circumferential track 586, a second converter 588 mounted to the second piston, and a second rotator 590. In such an example, the piston 506 would be a first piston, the undulating circumferential track 508 would be a first undulating circumferential track, the converter 510 would be a first converter, the rotator 514 would be a first rotator, and the output 572 would be a first output.

The rotating cylinder 504, the first and second pistons 506, 584, the first and second converters 510, 588, and when present, the first and second rotators 514, 590 may collectively define a rotating assembly 594. As shown in FIGS. 56-58, the rotating assembly 594 may be at least partially disposed within the cylindrical interior 522 and configured for rotation about the axis 524 and relative to the body 502. In some examples, the rotating cylinder 504 may be substantially rotationally fixed to the first and second rotators 514, 590, the first and second rotators 514, 590 may be substantially rotationally fixed to respective ones of the first and second converters 510, 588, and the first and second converters 510, 588 may be substantially axially fixed to respective ones of the first and second pistons 506, 584.

The second piston 584 may be disposed within the rotating cylinder 504 and configured for reciprocating motion along the axis 524. In some examples, the second piston 584 may rotate about the axis 524 with the second converter 588 as the second piston reciprocates along the axis.

As generally suggested in FIGS. 57 and 58, the first and second pistons 506, 584 may move along the axis 524 in opposite directions, with the rotating cylinder 504 and the first and second pistons 506, 584 collectively defining an expandable volume 596 between the first and second pistons. The first and second undulating circumferential tracks 508, 586 may be fixed relative to the body 502 and disposed proximate the respective first and second ends 518, 520 of the body. The second converter 588 may be engaged with the second undulating circumferential track 586 and configured to reciprocate with the second piston 584. The second undulating circumferential track 586 may cause the second converter 588 to rotate about the axis 524 as the second converter and the second piston 584 reciprocate along the axis.

The second rotator 590, which may be configured to rotate about the axis 524, may include a second output 598. The second rotator 590 may be engaged with the second converter 588, such as in a manner discussed above with regard to the first rotator and the first converter, such that rotation of the second converter 588 about the axis 524 causes the second rotator 590 to rotate about the axis.

Rotation of the first and second converters 510, 588 about the axis 524 may cause the rotating cylinder 504 to rotate about the axis. For example, the rotating cylinder 504 may be engaged with the first and second rotators 514, 590, which are caused to rotate about the axis 524 by the first and second converters 510, 588 rotating about the axis, such that the rotating cylinder rotates about the axis with the first and second rotators. As generally noted above and shown in FIG. 56, the ears 576 of rotating cylinder 504 may be engaged with the corresponding projections or edges 578 on the first and second rotators 514, 590, with a plurality of fasteners being installed at the corresponding locations 580 on the rotator and rotating cylinder.

As shown in FIGS. 57 and 58, the first undulating circumferential track 508 may be proximate the first end 602 of the engine 500 and the second undulating circumferential track 586 may be proximate the second end 604 of the engine. When the first and second undulating circumferential tracks 508, 586 are proximate the respective first and second ends of the engine, one or both of the first and second pistons 506, 584 may be disposed between the first and second undulating circumferential tracks.

The first and second outputs may comprise first and second shaft portions that are rotationally fixed relative to respective ones of the first and second converters and extend along the axis from the first and second ends of the engine. For example, as shown in FIGS. 57 and 58, the first and second outputs 572, 598 may comprise first and second shaft portions or stub shafts 574, 606 that extend from respective ones of the first and second rotators 514, 590 and are rotationally fixed to respective ones of the first and second converters 510, 588. The first and second stub shafts 574, 606 extend along the axis 524 from the first and second ends 602, 604 of the engine 500.

As suggested in FIGS. 57 and 58, the first and second outputs 572, 598 may be or include any suitable structure 608 that may be configured to transmit power and torque from the engine. Nonexclusive illustrative example of suitable structures to transmit power and torque may include pulleys, spur gears, bevel gears, or the like.

The engine 500 may be incorporated into larger and/or scalable engine systems or assemblies. For example, at least two examples of the engine 500 may be assembled into an engine assembly. The multiple examples may be arranged in parallel, transversely, and/or in series along the axis 524, with the resulting output axis being parallel or transverse to the axis 524. By “transverse” or “transversely,” as used herein, it is meant that the indicated elements are obliquely or perpendicularly oriented to one another.

The operation of engine 500, when powered by an externally compressed or pressurized gas, such as compressed air, may be understood with reference to FIGS. 57, 58, 59 and 61. As generally explained above, a compressed-gas engine using undulating circumferential tracks undergoes two power-exhaust cycles per revolution of its output shaft. Thus, when the engine is powered by an externally compressed gas, such as compressed air or steam, the rotating cylinder may include opposed ports and the body may include opposed inlet and exhaust openings. For example, as shown in FIGS. 59 and 61, the rotating cylinder 504 may include a second port 610 opposite the first port 546, and the body 502 may include a second inlet opening 612 opposite the first inlet opening 550 and a second exhaust opening 502 opposite the first exhaust opening 548.

By way of example, with the first and second pistons 506, 584 at their top dead center positions as illustrated in FIGS. 57 and 59, the first port 546 may be positioned between the first exhaust opening 548 and a first inlet opening 550, with the opposed second port 610 being positioned between the second exhaust opening 552 and the second inlet opening 612. After a small amount of rotation about the axis 524, as indicated by the arrow 544, of the rotating assembly 594 and the rotating cylinder 504, the first and second ports 546, 610 will begin to open to the respective first and second inlet openings 550, 612 when the leading edges 614 of the ports pass the near edges of the inlet openings. When the first and second inlet openings 550, 612 open, the compressed gas will force the first and second pistons 506, 584 apart and towards their bottom dead center positions (illustrated in FIG. 58). Continued rotation, as indicated by the arrow 544, will close the first and second ports 546, 610 to the respective first and second inlet openings 550, 612 when the trailing edges 616 of the ports pass the far edges of the inlet openings. Further rotation will begin to open the first and second ports 546, 610 to the respective second and first exhaust openings 552, 548 when the leading edges 614 of the ports pass the near edges of the exhaust openings, as shown in FIG. 61, where the first and second pistons 506, 584 are in their bottom dead center positions (illustrated in FIG. 58).

As a nonexclusive illustrative example, such as for a compressed air engine, the first and second ports 546, 610 on the rotating cylinder 504 and the first and second inlet openings 550, 612 on the body 502 may be sized and arranged such that the ports on the rotating cylinder may open to the inlet openings with the rotating assembly 594 rotated to about two (2) degrees after the pistons have reached top dead center and close with the rotating assembly 594 rotated to about ten (10) degrees before the pistons have reached bottom dead center. The first and second ports 546, 610 on the rotating cylinder 504 and the first and second exhaust openings 548, 552 on the body 502 may be sized and arranged such that the ports on the rotating cylinder may open to the exhaust openings with the rotating assembly 594 rotated to about two-point-six-five (2.65) degrees before the pistons have reached bottom dead center and close with the rotating assembly 594 rotated to about two-point-three-three (2.33) degrees before the pistons have reached top dead center. In such an example, each of the first and second ports 546, 610 may extend around the circumference of the rotating cylinder 504 for approximately forty-nine (49) degrees of rotational angle between the leading and trailing edges 614, 616 of the port, with the first and second ports 546, 610 being arranged about one-hundred-eighty (180) degrees apart, with about one-hundred-eighty (180) degrees between the leading edges of the respective ports.

In some examples, the engine may be configured such that at least one of the pistons is double-acting, or driven in both directions. For example, as shown in FIGS. 57, 60 and 62, in addition to the first or central port 546 on the rotating cylinder 504 and the first or central inlet and exhaust openings 550, 548 on the body 502, the rotating cylinder 504 may include a pair of end ports 618 that are axially spaced from the first port 546, and the body may include a pair of end inlet openings 620 that are axially spaced from the first inlet opening 550 and a pair of end exhaust openings 622 that are axially spaced from the first exhaust opening 548. Each of the pair of end ports 618 may be axially aligned with a corresponding one of the end inlet openings 620 and a corresponding one of the end exhaust openings 622. Thus, when the rotating cylinder 504 rotates within the body 502, each of the end ports 618 may be sequentially aligned with the corresponding ones of the end inlet and exhaust openings 620, 622.

When the engine includes double-acting pistons, the first piston 506 and the rotating cylinder 504 may collectively define a second expandable volume 626. The second piston 584 and the rotating cylinder 504 may collectively define a third expandable volume 628. As shown in FIGS. 57 and 58, the port 546, which may be a first port, may open into the first expandable volume 596, one of the end ports 618, which may be a second port, may open into the second expandable volume 626, and the other of the end ports 618, which may be a third port, may open in to the third expandable volume 628. In such an example, the liner 512 may radially support the rotating cylinder 504 over at least those portions of the rotating cylinder that correspond to or define the first, second and third expandable the volumes 596, 626, 628.

As suggested in FIGS. 57 and 58, expansion of the first expandable volume 596 may correspond to contraction of the second and third expandable volumes 626, 628. Accordingly, the expansion or power stroke of the first expandable volume 596 will be out of phase with the expansion or power stroke of the second and third expandable volumes 626, 628 by ninety (90) degrees of rotation of the rotating cylinder 504. Accordingly, the end ports 618 may be rotationally shifted or displaced about the axis 524 by about ninety (90) degrees relative to the port 546, with about ninety (90) degrees between the leading edges of the respective ports. The end ports 618 may be of a similar rotational width or size as the port 546, such that the end ports 618 may extend around the circumference of the rotating cylinder 504 for approximately forty-nine (49) degrees of rotational angle between the leading and trailing edges of the ports. Thus, if the end inlet and exhaust openings 620, 622 are of similar size to the central inlet and exhaust openings 550, 548, the end ports may open to the end inlet and exhaust openings at similar points of rotation of the rotating cylinder with regard to the location of the pistons within the second and third expandable volumes as was described above with regard to the port 546 and the central inlet and exhaust openings 550, 548. Accordingly, the power and exhaust operation with regard to the second and third expandable volumes may proceed similarly to the operation described above, albeit with a ninety (90) degree difference in the rotational position of the rotating cylinder for the power and exhaust strokes, as may be seen from comparison of FIGS. 59 and 61 to FIGS. 60 and 62, in view of FIGS. 57 and 58.

As shown in FIGS. 56-62, any of the ports, inlet openings and exhaust openings may include a corresponding opposed ports that is arranged about one-hundred-eighty (180) degrees apart from the port.

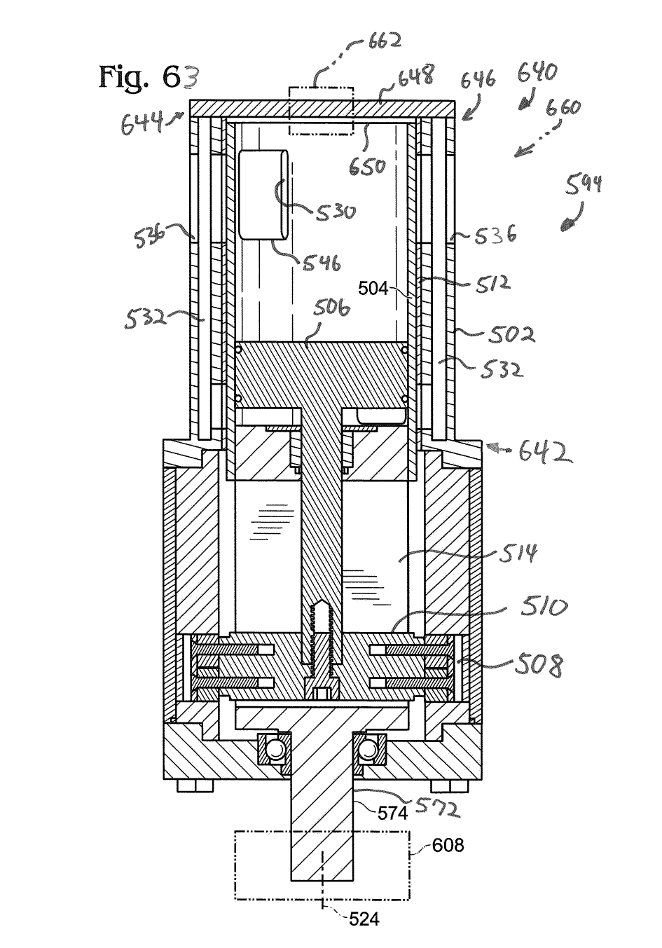

Another nonexclusive illustrative example of an engine is shown generally at 640 in FIG. 63. Unless otherwise specified, engine 640 and its various component parts may, but are not required to, contain at least one of the structures, components, functionalities, concepts, and/or variations described, illustrated, and/or incorporated herein. The engine 640 may include a case or body 502, a rotating cylinder 504, a single piston 506, a single undulating circumferential track 508, and a converter 510. In some examples, the engine 500 may include a liner 512 and/or a rotator 514. The engine 500 may additionally include various accessories and components as are known in the art for use with reciprocating engines. As shown in FIG. 63, the engine 640 essentially includes one-half of an engine 540, with the body 502 extending from a first end 642 proximate the undulating circumferential track 508 to a termination 644 at a second end 646 proximate where the piston 506 would be when at the top dead center position. The termination may include a cap 648 proximate a distal end 650 of the rotating cylinder 504. In some examples, a bearing may be provided between the distal end 650 of the rotating cylinder 504 and the cap 648.

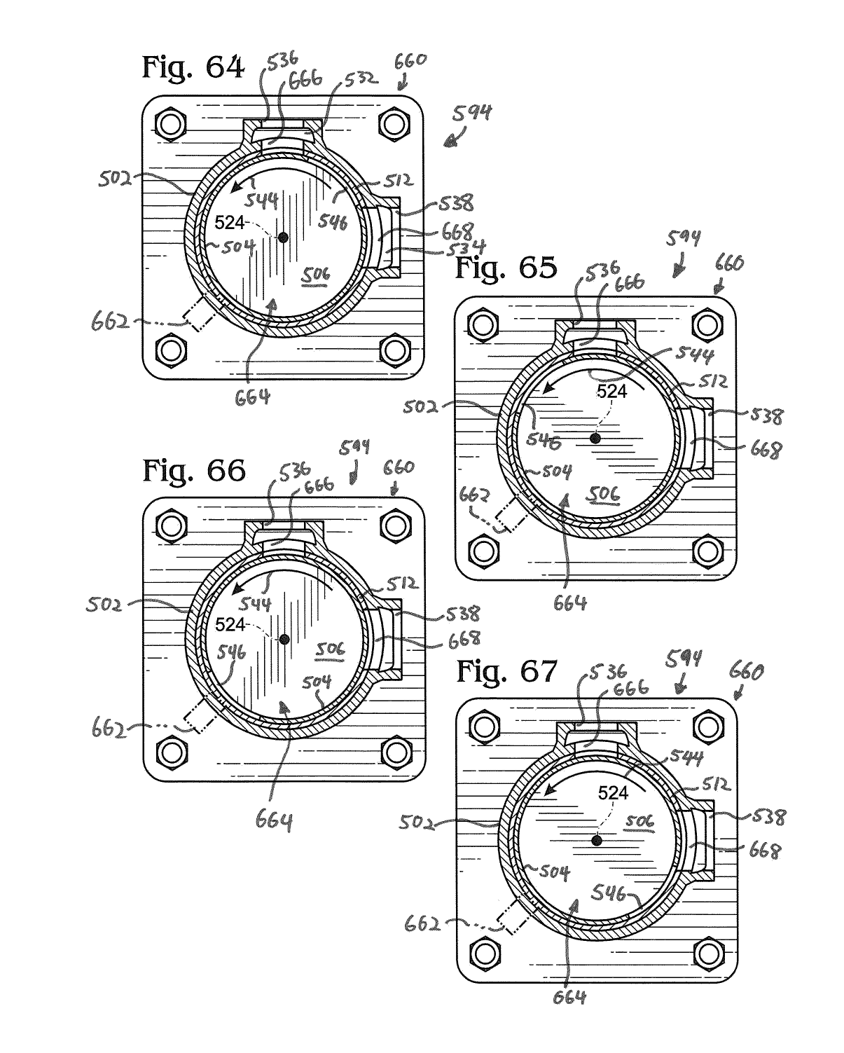

Another nonexclusive illustrative example of an engine is shown generally at 660 in FIG. 64-67. The operation of an engine 660 generally similar to engine 500, when operated as an internal combustion engine, may be understood with reference to FIGS. 57, 58 and 63-67. Unless otherwise specified, engine 660 and its various component parts may, but are not required to, contain at least one of the structures, components, functionalities, concepts, and/or variations described, illustrated, and/or incorporated herein. Examples of the engine 660 may include a single piston per rotating cylinder, as shown in FIG. 63, opposed pistons in the rotating cylinder, as shown in FIGS. 55-58, and/or double acting pistons, as discussed above. Likewise, the engine 500 and engine 640 discussed above may be configured as internal combustion engines if provided with an ignition source, a suitable arrangement of ports, inlet openings, and exhaust openings, such as generally described below.

As an internal combustion engine, engine 660 may include at least one ignition source 662 for each expandable volume 664 of the engine. The ignition source may be or include a spark plug, a glow plug, injection of a combustible fuel into the expandable volume, or the like.

For example, when the engine 660 includes opposed pistons, as shown in FIGS. 57 and 58, an ignition source 662 may be provided for the expandable volume 596 of the engine. In some examples, the ignition source 662 may be disposed on the body 502, as suggested in FIGS. 64-67, such that the ignition source is stationary and aligned with the port 46 on the rotating cylinder 504. Thus, the port 546 on the rotating cylinder 504 may be sequentially aligned with the inlet opening 666, the ignition source 662, and the exhaust opening 668 as the rotating cylinder 504 rotates within the body 502 about the axis 524.

In some examples, the ignition source may be at least partially disposed within the rotating assembly, such as within the rotating cylinder. In such examples, a rotational transmission of power or fuel would be made from a stationary part of the engine, such as the body, to within the rotating cylinder. For example, as suggested in FIG. 58, a first set of electrical contacts 670 or slip rings may be disposed on the body 502 or liner 512 and a second set of electrical contacts 672 or slip rings may be disposed on the rotating cylinder 504. The first set of electrical contacts 670 would periodically engage the second set of electrical contacts 672 as the rotating cylinder 504 rotates within the body 502 or liner 512, which may supply power to and activate the ignition source 662 to initiate combustion within the expandable volume. For example, engagement between the first and second sets of electrical contacts may supply current to a spark plug that is mounted within the rotating cylinder, such as within an intermediate head or separator mounted within the rotating cylinder and disposed between the first and second opposed pistons.

When the engine 660 includes a single piston, as shown in FIG. 63, the ignition source 662 may be may be mounted on the cap 648. In such an example the timing and supply of power or fuel to the ignition source may be independent of the rotating cylinder 504. However, in some examples with a single piston, the ignition source 662 may be mounted as discussed above with regard to engines having opposed pistons.

The operation of engine 660, based on internal combustion, may be understood with reference to FIGS. 64-67. In FIG. 64, the engine 660 is shown with the piston 506 at top dead center, at the start of the intake stroke. As the rotating assembly 594 and rotating cylinder 504 rotate about the axis 524, as indicated by the arrow 544, the port 546 will open to the inlet opening 666 during the intake stroke as the piston 506 moves toward bottom dead center. When the piston 506 is at bottom dead center, as shown in FIG. 65, the rotating assembly 594 and rotating cylinder 504 will have rotated ninety (90) degrees from the start position shown in FIG. 64 and the port 546 will have closed off the inlet opening 666 for the start of the compression stroke. At the completion of the compression stroke, the piston 506 will be at bottom dead center, and the rotating assembly 594 and rotating cylinder 504 will have rotated one-hundred-eighty (180) degrees from the start position. In some examples, the ignition source 662 may then be aligned with the port 546, as shown in FIG. 66, which may ignite the mixture within the expandable volume 664 to begin the power stroke. At the completion of the power stroke, when the piston reaches bottom dead center, the rotating assembly 594 and rotating cylinder 504 will have rotated two-hundred-seventy (180) degrees from the start position, and the port 546 will open to the exhaust opening 668, as shown in FIG. 67, to begin the exhaust stroke.

As may be recognized from FIGS. 64-67 and the foregoing description of the internal combustion engine 660, replacing a conventional cam shaft and valve train with the rotating cylinder as used with the undulating circumferential track may permit a simpler engine construction. In particular, such an engine experiences four strokes of the piston for every rotation of the shaft. Accordingly, all four cycles occur during a single rotation of the shaft and the rotating cylinder, which may eliminate the need for the timing gears, belts and/or chains commonly used to rotate a cam shaft at half the speed of the crankshaft.

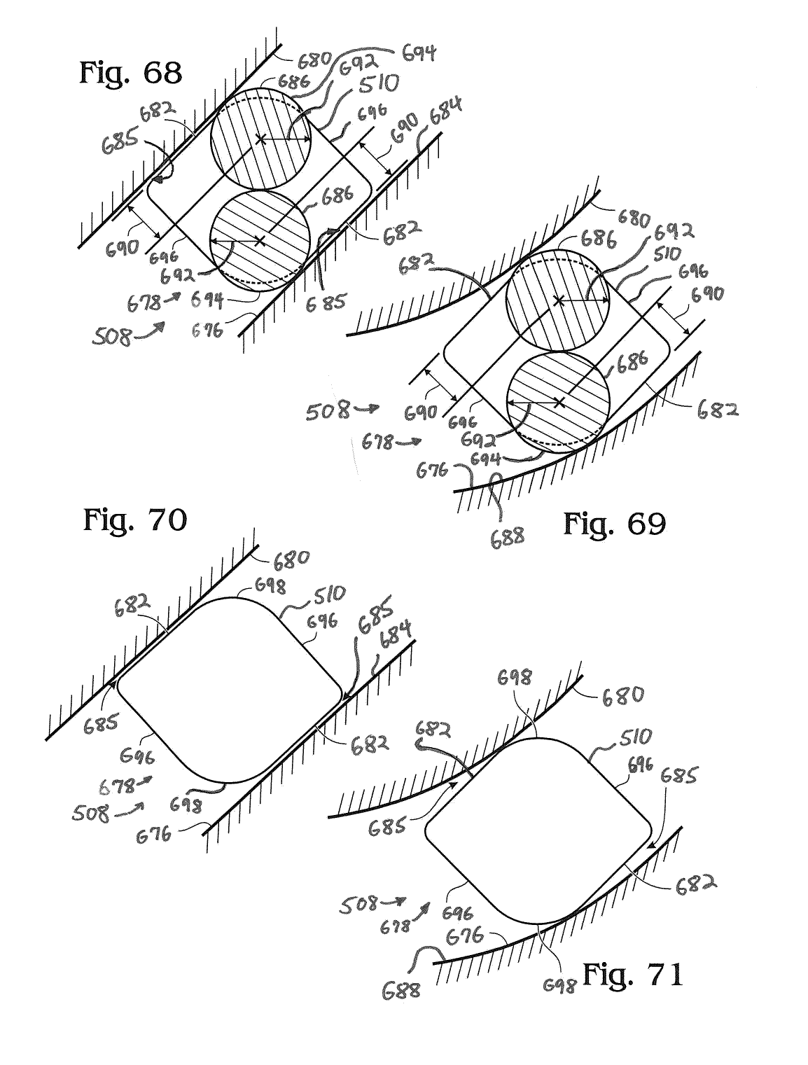

As shown in FIGS. 68-71, the undulating circumferential track 508 may include at least one bearing surface 676, with at least one of the converters 510 including a contact portion 678 engaged with the bearing surface 676 of the undulating circumferential track 508. As generally discussed above, the engagement between the contact portion 678 and the bearing surface 676 of the track 508 may cause the converter 510, and in some examples the piston as well, to rotate about the axis 524 as the piston and the converter reciprocate along the axis. As shown in FIGS. 68-71, the contact portion may, in some examples, engage an opposed bearing surface 680 of the track 508.

In some examples, as shown in FIGS. 68 and 69, the contact portion 678 may include a sliding surface 682 configured to slide along at least a first portion 684 of the bearing surface 676, such as along a film 685 of oil or other lubricant, and a roller 686 configured to roll along at least a second portion 688 of the bearing surface 676. As shown in FIGS. 68 and 69, the contact portion 678 may include an opposed sliding surface 682 that is opposite the first sliding surface and configured to slide along at least a first portion 684 of the opposed bearing surface 680, such as along a film 685 of oil or other lubricant. The contact portion 678 may include an opposed roller 686 that is opposite the first roller and configured to roll along at least a second portion 688 of the opposed bearing surface 680.

The contact portion 678 may be configured such that first and second portions of the bearing surface 676 are particular parts and/or configurations of the bearing surface, as well as being particular percentages thereof. For example, the contact portion 678 may be configured such that the sliding surface 682 slides along about 70% to about 90% of the bearing surface 676, while the roller 686 rolls along about 10% to about 30% of the bearing surface 676.

In some examples, the first and second portions of the bearing surface may be mutually exclusive. For example, there may be a relatively abrupt transition between the sliding surface 682 sliding along the bearing surface 676 and the roller 686 rolling along the bearing surface 676. In some examples, the first and second portions of the bearing surface may be at least partially coextensive. For example, there may be a relatively gradual or prolonged transition between the sliding surface 682 sliding along the bearing surface 676 and the roller 686 rolling along the bearing surface 676.

The first portion of the bearing surface may at least partially correspond to movement of the piston and converter along the axis in a first axial direction. For example, as shown in FIG. 68, where the illustrated part of the track 508 is relatively constantly sloped, the piston would be moving along the axis between the top dead center and bottom dead center positions. The movement of the piston and converter along the axis in the first axial direction may be substantially uniform, as where the sliding surface 682 is sliding along a relatively constantly sloped portion of the bearing surface 676.

The second portion of the bearing surface may at least partially correspond to decelerating movement of the piston and converter along the axis in the first axial direction. For example, as shown in FIG. 69, the slope of the bearing surfaces 676 is changing as the piston approaches the corresponding top dead center or bottom dead center position, which corresponds to deceleration of the piston prior to a direction change.

The second portion of the bearing surface may at least partially correspond to accelerating movement of the piston and converter along the axis in a second axial direction opposite to the first axial direction. For example, after the piston and converter have finished moving along the axis in the first axial direction, such as where the piston has reached the top dead center or bottom dead center position, the piston and converter reverses direction and then begins to accelerate along the axis in the second axial direction as the piston continues to reciprocate along the axis between the top dead center and bottom dead center positions.

The sliding surface 676 may be spaced a particular distance 690 from the center of the roller 686, with the distance being measured perpendicularly to the sliding surface. In some examples, the distance 690 may be larger than the radius 692 of the roller such that sliding of the sliding surface 682 is predominant on certain portions of the bearing surface, such as those with a relatively constant slope, as suggested in FIG. 68. In such an example, the transition between the sliding surface 682 sliding along the bearing surface 676 and the roller 686 rolling along the bearing surface 676 may be relatively closer to the point at which the piston reverses direction. In some examples, the distance 690 may be smaller than the radius 692, which may result in the roller 686 rolling along a substantial portion of, or even substantially the entire, the bearing surface 676. In some examples, the distance 690 may be about the same as the radius 692 such that the sliding surface 682 is substantially tangent to the exterior surface 694 of the roller 686. In such an example, the transition between the sliding surface 682 sliding along the bearing surface 676 and the roller 686 rolling along the bearing surface 676 may relatively early, such as proximate the end of a substantially constantly sloped portion of the bearing surface 676.

In some examples, the contact portion 678 may include a second sliding surface 696 that is transverse to the first sliding surface 682 and proximate the roller 686, as shown in FIG. 68. In such an example, the second sliding surface 696 would slide along portions of the bearing surface 676 that have a slope substantially opposite to the slope shown in FIG. 68. The contact portion 678 may include an opposed second sliding surface 696 that is opposite the second sliding surface and configured to slide along portions of the opposed bearing surface 680.

In some examples, as shown in FIGS. 70 and 71, the contact portion 678 may include a sliding surface 682 configured to slide along at least a first portion 684 of the bearing surface 676 and a curved transitional sliding surface 698 configured to slide along at least a second portion 688 of the bearing surface 676. As shown, the sliding surface 682 may be adjacent the curved transitional sliding surface. The contact portion 678 may include an opposed sliding surface 682 that is opposite the first sliding surface and configured to slide along at least a first portion 684 of the opposed bearing surface 680. The contact portion 678 may include an opposed curved transitional sliding surface 698 configured to slide along at least a second portion 688 of the opposed bearing surface 680.

In some examples, the contact portion 678 may include a second sliding surface 696 that is transverse to the first sliding surface 682 and adjacent to the curved transitional sliding surface 698. In such an example, the second sliding surface 696 would slide along portions of the bearing surface 676 that have a slope substantially opposite to the slope shown in FIG. 70. The contact portion 678 may include an opposed second sliding surface 696 that is opposite the second sliding surface and configured to slide along portions of the opposed bearing surface 680.

Each of the sliding surface 682, curved transitional sliding surface 698, and second sliding surface 696 may be configured to slide along a film 685 of oil or other lubricant.

In some examples, the first and second portions of the bearing surface may be mutually exclusive. For example, there may be a relatively abrupt transition between the sliding surface 682 sliding along the bearing surface 676 and the curved transitional sliding surface 698 sliding along the bearing surface 676. In some examples, the first and second portions of the bearing surface may be at least partially coextensive. For example, there may be a relatively gradual or prolonged transition between the sliding surface 682 sliding along the bearing surface 676 and curved transitional sliding surface 698 sliding along the bearing surface 676.

The first portion of the bearing surface may at least partially correspond to movement of the piston and converter along the axis in a first axial direction. For example, as shown in FIG. 70, where the illustrated part of the track 508 is relatively constantly sloped, the piston would be moving along the axis between the top dead center and bottom dead center positions. The movement of the piston and converter along the axis in the first axial direction may be substantially uniform, as where the contact portion 678 is moving or sliding along a relatively constantly sloped portion of the bearing surface 676.

The second portion of the bearing surface may at least partially correspond to decelerating movement of the piston and converter along the axis in the first axial direction. For example, as shown in FIG. 71, where the slope of the bearing surfaces 676 is changing as the piston approaches the corresponding top dead center or bottom dead center position, which corresponds to deceleration of the piston prior to a direction change.

In some examples, the sliding surface 682 may have a surface area, area of contact with the bearing surface 676, and/or sliding surface area of approximately one (1) square inch (approximately 6.45 square centimeters).

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. An engine, comprising:
a body having a cylindrical interior defining an axis, wherein the body includes an inlet opening and an exhaust opening;
a liner mounted within the cylindrical interior;
a rotating cylinder disposed within the liner and configured for rotation about the axis and relative to the liner and the body, wherein the rotating cylinder includes a port that is sequentially aligned with the inlet and exhaust openings on the body as the rotating cylinder rotates within the body;
a piston disposed within the rotating cylinder and configured for reciprocating motion along the axis;
an undulating circumferential track; and
a converter mounted to the piston, engaged with the undulating circumferential track, and configured to reciprocate with the piston, wherein the track causes the converter to rotate about the axis as the converter reciprocates along the axis, and the rotating cylinder rotates with the converter.

2. The engine of claim 1, wherein the rotating cylinder fits within the liner sufficiently closely that the port is effectively sealed by the liner when the port is not aligned with either of the inlet and exhaust openings.

3. The engine of claim 2, wherein the liner comprises a material selected to reduce friction between the liner and the rotating cylinder.

4. The engine of claim 3, wherein the material comprises a molybdenum disulphide filled nylon.

5. The engine of claim 3, wherein the material comprises a ceramic.

6. The engine of claim 2, wherein the piston reciprocates within a first portion of the rotating cylinder, and the liner radially supports the first portion of the rotating cylinder.

7. The engine of claim 1, wherein the piston includes a piston head and a piston shaft extending along the axis from the piston head to a distal end, and the converter is removably mounted to the piston shaft.

8. The engine of claim 1, wherein the piston rotates about the axis with the converter as the converter and piston reciprocate along the axis.

9. The engine of claim 1, comprising a rotator configured to rotate about the axis and including an output, wherein the rotator is engaged with the converter such that rotation of the converter about the axis causes the rotator to rotate about the axis.

10. The engine of claim 9, wherein the rotator is engaged with the rotating cylinder such that rotation of the rotator about the axis causes the rotating cylinder to rotate about the axis.

11. The engine of claim 9, wherein the output of the first rotator includes a first shaft portion.

12. The engine of claim 9, wherein the undulating circumferential track is disposed between the piston and the output.

13. The engine of claim 9, wherein the piston is a first piston, the undulating circumferential track is a first undulating circumferential track, the converter is a first converter, the rotator is a first rotator and the output is a first output, the engine comprising:
a second piston disposed within the rotating cylinder and configured for reciprocating motion along the axis;
a second undulating circumferential track;
a second converter mounted to the second piston, engaged with the second undulating circumferential track, and configured to reciprocate with the second piston, wherein the second track causes the second converter to rotate about the axis as the second converter reciprocates along the axis; and
a second rotator configured to rotate about the axis and including a second output, wherein the second rotator is engaged with the second converter such that rotation of the second converter about the axis causes the second rotator to rotate about the axis.

14. The engine of claim 13, wherein the rotating cylinder is engaged with the first and second rotators such that the rotating cylinder rotates about the axis with the first and second rotators.

15. The engine of claim 13, wherein the engine extends from a first end to a second end, the first undulating circumferential track is proximate the first end of the engine, the second undulating circumferential track is proximate the second end of the engine, and at least one of the first and second pistons is disposed between the first and second undulating circumferential tracks.

16. The engine of claim 15, wherein the first and second outputs comprise first and second shaft portions extending from the first and second ends of the engine.

17. The engine of claim 13, wherein the first and second pistons move along the axis in opposite directions, the rotating cylinder and the first and second pistons collectively define an expandable volume between the first and second pistons, and an ignition source is provided for the expandable volume.

18. The engine of claim 17, wherein the ignition source is disposed within the rotating cylinder.

19. The engine of claim 18, wherein:
the ignition source is selected from the group consisting of spark plugs and glow plugs;
a first set of electrical contacts are disposed on the liner;
a second set of electrical contacts are disposed on the rotating cylinder; and
the first set of electrical contacts periodically engages the second set of electrical contacts as the rotating cylinder rotates within the body to activate the ignition source.

20. The engine of claim 17, wherein the ignition source is disposed on the body, and the port is sequentially aligned with the inlet opening, the ignition source and the exhaust opening as the rotating cylinder rotates within the body.

21. The engine of claim 1, wherein:
the port is a first port, the inlet opening is a first inlet opening, and the exhaust opening is a first exhaust opening;
the first port is axially aligned with the first inlet and exhaust openings on the body;
the body includes a second inlet opening axially spaced from the first inlet opening;
the body includes a second exhaust opening axially spaced from the first exhaust opening;
the rotating cylinder includes a second port axially aligned with the second inlet and exhaust openings on the body, wherein the second port is rotationally displaced about the axis approximately ninety degrees relative to the first port, and the second port is sequentially aligned with the second inlet and exhaust openings as the rotating cylinder rotates within the body.

22. The engine of claim 1, wherein the port is a first port, the inlet opening is a first inlet opening, the exhaust opening is a first exhaust opening, the rotating cylinder includes a second port opposite the first port, the body includes a second inlet opening opposite the first inlet opening, and the body includes a second exhaust opening opposite the first exhaust opening.

23. The engine of claim 1, wherein the converter extends from a first end to a second end, the first end of the converter engages a first part of the undulating circumferential track, and the second end of the converter engages a second part of the undulating circumferential track opposite the first part.

24. The engine of claim 1, wherein the undulating circumferential track includes a bearing surface, the converter includes a contact portion engaged with the bearing surface, engagement between the contact portion and the bearing surface of the track causes the converter to rotate about the axis as the converter reciprocates along the axis, and the contact portion includes a sliding surface configured to slide along at least a first portion of the bearing surface and a roller configured to roll along at least a second portion of the bearing surface.

25. An engine, comprising:
a body extending between first and second ends, wherein the body includes an inlet opening, an exhaust opening, and a cylindrical chamber defining an axis;
first and second undulating circumferential tracks fixed relative to the body and disposed proximate the respective first and second ends of the body; and
a rotating assembly at least partially disposed within the cylindrical chamber and configured for rotation about the axis and relative to the body, the rotating assembly comprising:
a rotating cylinder having a port axially aligned with the inlet and exhaust openings on the body, wherein the port is sequentially aligned with the inlet and exhaust openings as the rotating cylinder rotates about the axis;
first and second pistons disposed within the rotating cylinder and configured for reciprocating motion along the axis, wherein the first and second pistons move along the axis in opposite directions, and the rotating cylinder and the first and second pistons collectively define an expandable volume between the first and second pistons;
a first converter mounted to the first piston and engaged with the first undulating circumferential track, wherein the first track causes the first converter to rotate about the axis as the first piston reciprocates along the axis; and
a second converter mounted to the second piston and engaged with the second undulating circumferential track, wherein the second track causes the second converter to rotate about the axis as the second piston reciprocates along the axis, and rotation of the first and second converters about the axis causes the rotating cylinder to rotate about the axis.

26. The engine of claim 25, comprising:
a first rotator configured to rotate about the axis and including a first output shaft, wherein the first rotator is engaged with the first converter such that rotation of the first converter about the axis causes the first rotator to rotate about the axis; and
a second rotator configured to rotate about the axis and including a second output shaft, wherein the second rotator is engaged with the second converter such that rotation of the second converter about the axis causes the second rotator to rotate about the axis.

27. The engine of claim 26, wherein the rotating cylinder is substantially rotationally fixed to the first and second rotators, the first and second rotators are substantially rotationally fixed to respective ones of the first and second converters, and the first and second converters are substantially axially fixed to respective ones of the first and second pistons.

28. The engine of claim 25, comprising first and second output shafts rotationally fixed to respective ones of the first and second converters and extending along the axis.

29. The engine of claim 25, wherein an ignition source is provided for the expandable volume.

30. The engine of claim 29, wherein the ignition source is disposed within the rotating cylinder, and is selected from the group consisting of spark plugs and glow plugs.

31. The engine of claim 29, wherein the ignition source is disposed on the body, and the port is sequentially aligned with the inlet opening, the ignition source and the exhaust opening as the rotating cylinder rotates about the axis.

32. The engine of claim 25, wherein:
the port is a first port, the inlet opening is a first inlet opening, the exhaust opening is a first exhaust opening, the expandable volume between the first and second pistons is a first expandable volume, and the first port opens into the first expandable volume;
the first piston and the rotating cylinder collectively define a second expandable volume;
the second piston and the rotating cylinder collectively define a third expandable volume;
expansion of the first expandable volume corresponds to contraction of the second and third expandable volumes;
the body includes second and third inlet openings axially spaced from the first inlet opening;
the body includes second and third exhaust openings axially spaced from the first exhaust opening;
the rotating cylinder includes a second port that opens into the second expandable volume and is sequentially aligned with the second inlet and exhaust openings as the rotating cylinder rotates within the body; and
the rotating cylinder includes a third port that opens into the third expandable volume and is sequentially aligned with the third inlet and exhaust openings as the rotating cylinder rotates within the body.

33. The engine of claim 32, wherein the second and third ports are rotationally displaced about the axis approximately ninety degrees relative to the first port.

34. The engine of claim 32, comprising a liner mounted within the cylindrical chamber, wherein the rotating cylinder is disposed within the liner and configured for rotation about the axis and relative to the liner.

35. The engine of claim 34, wherein the liner radially supports the rotating cylinder over at least portions of the rotating cylinder that define the first, second and third expandable volumes.

36. The engine of claim 25, wherein the first piston rotates about the axis with the first converter as the first piston reciprocates along the axis, and the second piston rotates about the axis with the second converter as the second piston reciprocates along the axis.

37. The engine of claim 25, wherein the first undulating circumferential track includes a bearing surface, the first converter includes a contact portion engaged with the bearing surface, engagement between the contact portion and the bearing surface causes the first converter and the first piston to rotate about the axis as the first piston reciprocates along the axis, and the contact portion includes a sliding surface configured to slide along at least a first portion of the bearing surface and a roller configured to roll along at least a second portion of the bearing surface.

38. The engine of claim 25 assembled into an engine assembly, the engine assembly comprising at least two examples of the engine arranged in series along the axis.

39. An engine, comprising:
a piston configured for reciprocating motion along an axis;
an undulating circumferential track extending around the axis, wherein the track comprises a bearing surface; and
a converter mounted to the piston for reciprocation therewith and including a contact portion engaged with the bearing surface of the undulating circumferential track, wherein the engagement between the contact portion and the bearing surface of the track causes the converter to rotate about the axis as the converter reciprocates along the axis; and
wherein the contact portion includes a sliding surface configured to slide along at least a first portion of the bearing surface and a roller configured to roll along at least a second portion of the bearing surface.

40. The engine of claim 39, wherein the first and second portions of the bearing surface are mutually exclusive.

41. The engine of claim 39, wherein the first and second portions of the bearing surface are at least partially coextensive.

42. The engine of claim 41, wherein the first portion of the bearing surface at least partially corresponds to movement of the piston and converter along the axis in a first axial direction, and the second portion of the bearing surface at least partially corresponds to decelerating movement of the piston and converter along the axis in the first axial direction.

43. The engine of claim 39, wherein the first portion of the bearing surface at least partially corresponds to substantially uniform movement of the piston and converter along the axis in a first axial direction, and the second portion of the bearing surface at least partially corresponds to decelerating movement of the piston and converter along the axis in the first axial direction and accelerating movement of the piston and converter along the axis in a second axial direction opposite to the first axial direction.

44. The engine of claim 39, wherein the roller has a radius, the sliding surface is spaced a distance from the center of the roller, the distance is measured perpendicularly to the sliding surface, and the distance is larger than the radius.

45. The engine of claim 39, wherein the roller has a radius, the sliding surface is spaced a distance from the center of the roller, the distance is measured perpendicularly to the sliding surface, and the distance is smaller than the radius.

46. The engine of claim 39, wherein the roller has an exterior surface and the sliding surface is substantially tangent to the exterior surface of the roller.

47. The engine of claim 39, comprising:
a body having a cylindrical interior extending along the axis, wherein the body includes an inlet opening and an exhaust opening;
a rotating cylinder disposed within the cylindrical interior and configured for rotation about the axis, wherein the rotating cylinder includes a port that is sequentially aligned with the inlet and exhaust openings on the body as the rotating cylinder rotates within the cylindrical interior; and
an output configured to rotate about the axis, wherein the output is engaged with the converter and the rotating cylinder is engaged with the output such that rotation of the converter about the axis causes the output and the rotating cylinder to rotate about the axis.

48. An engine, comprising:
a piston configured for reciprocating motion along an axis;
an undulating circumferential track extending around the axis, wherein the track comprises a bearing surface; and
a converter mounted to the piston for reciprocation therewith and including a contact portion engaged with the bearing surface of the undulating circumferential track, wherein the engagement between the contact portion and the bearing surface of the track causes the converter to rotate about the axis as the converter reciprocates along the axis; and
wherein the contact portion includes a sliding surface configured to slide along at least a first portion of the bearing surface and a curved transitional sliding surface configured to slide along at least a second portion of the bearing surface.

49. The engine of claim 48, wherein the sliding surface is adjacent the curved transitional sliding surface.

50. The engine of claim 49, wherein the sliding surface is a first sliding surface, and the contact portion includes a second sliding surface transverse to the first sliding surface and adjacent to the curved transitional sliding surface.

51. The engine of claim 48, wherein the first and second portions of the bearing surface are mutually exclusive.

52. The engine of claim 48, wherein the first portion of the bearing surface at least partially corresponds to movement of the piston and converter along the axis in a first axial direction, and the second portion of the bearing surface at least partially corresponds to decelerating movement of the piston and converter along the axis in the first axial direction.

53. The engine of claim 48, wherein the first portion of the bearing surface at least partially corresponds to substantially uniform movement of the piston and converter along the axis in a first axial direction, and the second portion of the bearing surface at least partially corresponds to decelerating movement of the piston and converter along the axis in the first axial direction and accelerating movement of the piston and converter along the axis in a second axial direction opposite to the first axial direction.

54. The engine of claim 48, comprising:
a body having a cylindrical interior extending along the axis, wherein the body includes an inlet opening and an exhaust opening;
a rotating cylinder disposed within the cylindrical interior and configured for rotation about the axis, wherein the rotating cylinder includes a port that is sequentially aligned with the inlet and exhaust openings on the body as the rotating cylinder rotates within the cylindrical interior; and
an output configured to rotate about the axis, wherein the output is engaged with the converter and the rotating cylinder is engaged with the output such that rotation of the converter about the axis causes the output and the rotating cylinder to rotate about the axis.
